(19) United States
(12) Patent Application Publication
(10) Pub. No.: US 2010/0186524 A1
(43) Pub. Date: Jul. 29, 2010

(54) Aerosol Collection and Microdroplet Delivery for Analysis

(75) Inventors: Peter C. Ariessohn, Lake Tapps, WA (US); Igor V. Novosselov, Seattle, WA (US)

Correspondence Address: K. Karel Lambert, P.O. Box 4063, Renton, WA, 98057, US

(73) Assignee: ENERTECHNIX, INC, Maple Valley, WA (US)

(21) Appl. No.: 12/364,672

(22) Filed: Feb. 3, 2009

Related U.S. Application Data
(60) Provisional application No. 61/026,376, filed on Feb. 5, 2008.

(51) Int. Cl. G01N 1/22; G01J 3/44

(52) U.S. Cl. 73/863.22; 356/301

(57) ABSTRACT

An apparatus or device for collecting aerosol particles from a gas stream, having a collector body enclosing a collector channel, a particle trap in the collector channel, and an injection duct for injecting a discrete microdroplet of an elution reagent. The particle trap may be a centrifugal impactor, a bluff body impactor, or an electrostatic impactor. Aerosol particles are deposited on the surface during collection and are subsequently eluted with a microdroplet or a series of microdroplets as a concentrated liquid sample so that the sample can be analyzed in situ or conveyed to a detector for analysis. The collector serves as an aerosol-to-liquid conversion module as part of an apparatus for detecting and analyzing aerosol particles, and may be used in an integrated environmental threat assessment system, for example for characterization of aerosolized chemical and biological weapons, or for industrial or environmental monitoring.

### RELATED APPLICATIONS

The present application claims the benefit of priority under 35 USC 119(e) to U.S. Patent Application No. 61/026,376 filed on 05 Feb. 2008.

### GOVERNMENT SUPPORT

The United States Government has rights in this invention pursuant to Grant No. NBCHC060109 awarded by the Department of Homeland Security, and Grant No. 1R43ES016390-01 awarded by the National Institutes of Health.

### BACKGROUND

Aerosols from natural, anthropogenic and industrial sources have long been recognized as a potential threat to human health; to that list of sources we now must add airborne chemical or biological warfare agents as a source of potentially lethal exposure or terrorist threat. Effective sampling and collection of aerosol particles is a critical first step in the detection and identification of these hazards. Identification methods such as immunological or nucleic acid assays typically require the aerosol sample to be suspended in a liquid medium. There is therefore a need for a “front-end” device adapted to collect these aerosols and prepare or deliver them in a concentrated suspension or solution for analysis.

Higher concentration of aerosol particles in a liquid sample achieves greater sensitivity for many analyses. Today's microanalytical instruments require microliter or nanoliter sample volumes, and larger volumes of liquid are difficult to process. Moreover, currently available aerosol collectors cannot readily be adapted to perform sample preprocessing prior to analysis, a significant disadvantage for integrated sampling and detection platforms.

Sample preprocessing includes processes such as dissolution of sample matrix, lysis of suspect cellular contents, or preliminary screening to trigger more exhaustive analysis, process steps which speed threat detection and avoid unnecessary analyses.

Current aerosol collection devices that provide liquid samples for analysis, such as wetted wall cyclones, wetted rotating vane impactors, and liquid impingers, are inefficient and produce large volume liquid samples, and are not well adapted to concentrating an aerosol. Large sample volumes are suitable for use with assays using 96- or 384-well plates, but the current trend is towards smaller scale, more-automated procedures using microfluidics, which demand much smaller sample volumes. Importantly, liquid phase collectors of the prior art cannot simply be miniaturized because of the drying effects of evaporation during operation and the difficulty in holding in place a small volume of a liquid under a stream of high velocity gas.

For example, in US Patent Application 2004/0232052 to Call, a “liquid jet” (see FIGS. 19 and 20A of US 2004/0232052) is applied so that samples are “blasted off the collection surface” (p. 22, para. 0238) into a sample container. Such a procedure can only result in losses of sample and increased dilution, and is likely not workable.

Thus there remains a need for a collector capable of efficiently concentrating an aerosol from a large volume of air into a few microliters or nanoliters of a liquid sample. In this regard, the field of microfluidics has revolutionized many aspects of chemistry and microbiology and is an enabling technology for the development of a wide range of detection and identification methods. Following the pioneering work of Wilding (U.S. Pat. Nos. 5,304,487, 5,376,252, 5,726,026, 5,955,029, 6,953,676), continuous and intermittent-flow microfluidic devices have been developed that carry out nucleic acid and immunological analyses in integrated devices fabricated on silicon or glass substrates. Digital microfluidic devices employ technologies such as electro-wetting, diaelectrophoresis, or microhydraulics to move, mix, combine and split microliter and nanoliter volumes and allow chemical and biological assays to be automated and carried out at very small scales. These advances offer substantial advantages in speed and accuracy while greatly reducing the need for operator involvement and minimizing reagent volumes. However, the problem of developing an effective “front-end” interface for ambient aerosol particle concentration, collection, and delivery in a nano- or microvolume to “back-end” analytical instrumentation has not been addressed.

Aerosol pre-concentration, prior to sample collection, offers a significant advantage when coupled to an analytical method. Using a variety of devices known in the art as “virtual impactors”, aerosol particles to be sampled from a larger volume of air are concentrated into a particle-enriched gas stream of smaller volume (the “minor flow”) while the bulk of the sampled air, depleted of particles, (also termed the “major flow” or “bulk flow”) is discarded. Such an aerosol concentrating device is described in US Patent Application 2008/0022853, entitled “Aerodynamic Lens Particle Separator”, and is co-assigned to the Applicant. Other air-to-air concentrators include virtual impactors such as the US Army's XM2 virtual impactor, those described in U.S. Pat. Nos. 3,901,798, 4,670,135, 4,767,524, 5,425,802, 5,533,406 and 6,698,592, and others.

An aerosol-to-liquid collection and delivery system that accepts raw or concentrated aerosols and delivers resuspended or solubilized aerosol particles in small droplets of fluid will serve as the front end to a number of biochemical or physical detection platforms. Initial demand is expected to be primarily in the security, military, and biomedical fields, but also in environmental and industrial sampling and monitoring applications, and will be driven to smaller sample volumes by technological advances in the development and integration of detection platforms and assays, including and not limited to both in situ and downstream assays for particles and particle constituents.

### SUMMARY OF THE INVENTION

This invention addresses the problem of collecting and microeluting captured aerosol particles, or their constituents, from particle traps in very small volumes. A collector module of the invention is designed so that aerosol particles are first collected in a particle trap, which may be an inertial impactor or an electrostatic impactor, within a collector channel, and a microdroplet or series of microdroplets are then introduced so as to contact a correspondingly small surface of the particle trap. The elution microdroplet is closely confined within the collector channel, which is of microfluidic or near-microfluidic dimensions. The aerosol particles deposited in the trap are eluted as a liquid suspension or solution in a discrete microdroplet volume. In another aspect of the invention, the sample material is reacted or treated in situ in preparation for analysis or analyzed in situ by physical, chemical, biochemical or molecular methods, “in situ” indicating that the reactions, treatment or analysis of the liquid sample are conducted in the particle trap.

Using these methods and apparatus, we have discovered that an impacted aerosol particle sample can be eluted from microfluidic-scale impactor surfaces in a constrained space with a very small droplet or a series of droplets of elution fluid, even nanoliter-sized droplets, enabling large concentration factors and increased sensitivity and robustness in detection of aerosol particles or their constituents of interest. The foremost technical advantage is the ability to achieve extremely high concentration factors and prepare the collected sample material for analysis in extremely small droplets in near real time.

Impaction on an impactor surface is an attractive method of capturing aerosol particles and aerosol particles from a concentrated particle stream at high velocity. The velocity of impaction may approach or exceed 50 m/s, depending on the desired particle size cut-off, and sample materials impacted at such velocities typically resist removal from the impactor. However, unless first eluted from the impactor surface, these adherent sample materials are not generally accessible for many kinds of analyses. Inability to elute the sample material in a liquid volume can result in failure to detect a bioaerosol, particulate toxin or other aerosol particle of interest. Surprisingly, “micro-elution” is successfully achieved by confining the elution fluid to a very small volume in contact with a correspondingly small impactor surface. This phenomenon is relevant to both inertial impactors and electrostatic impactors.

The ability of these devices to collect large numbers of aerosol particles in a short time and deliver them in very small fluid volumes offers the possibility to greatly enhance the speed and sensitivity of existing detection methods. A method of this approach includes (i) directing a concentrated gas stream containing aerosol particles, typically received from a virtual impactor or other air-to-air concentrator, into an enclosed collector channel with small internal dimensions, (ii) impacting the aerosol particles in a particle trap within the collector channel, thereby reversibly adhering the particles to a small impactor surface, (iii) periodically eluting captured aerosol particles as a suspension or a solution from the surface in a liquid sample by injecting a discrete microdroplet volume or a series of microdroplet volumes of an elution reagent into the particle trap and contacting the liquid with the impactor surface, then (iv) optionally performing in-situ sample pre-treatment of the collected particles, for example by mixing a reagent with the liquid sample, (v) optionally performing in-situ analysis of the sample by physical, chemical, biochemical, or molecular methods, or (vi), optionally conveying the liquid sample out of the collector channel to a sampling port. The microdroplet volume is a discrete volume, indicating that the fluid is not a continuous stream of flow. In one aspect, a discrete volume of ten microliters or less, more preferably 1000 nanoliters or less, is applied to the impactor surface. Impactor surfaces include centrifugal impactors, bluff body impactors, and electrostatic impactors. Forces responsible for impaction of the particles include inertial forces and electrostatic forces.

At least one internal cross-sectional dimension of the collector channel proximate to the particle trap impactor surface may be less than 1500 micrometers, thereby confining the microdroplet in contact with the impactor surface. We demonstrate elution here using very small droplet volumes of a liquid reagent. Injection of precisely controlled discrete microvolumes of a reagent fluid into the particle trap can be achieved using ink jet printing technology, for example.

Transporting or conveying the microdroplet through the collector channel can be accomplished in a variety of ways. These include “pump functionalities” as broadly encompassed herein. Applying a pressure differential, such as a suction pressure applied to the collector channel, is a simple approach. Pump functionalities include microfluidic diaphragm pumps, syringe pumps, piezo-electric pumps, inkjet printing pumps generally, positive displacement pumps, magnetostrictive diaphragm pumps, electrostatic pumps, thermopropulsive pumps, and Gibbs-Marangoni pumps, such as are useful for applying a pumping force to a liquid sample in the collector channel, and may be mounted in or on the collector body or placed remotely in a larger apparatus of which the collector module is part. These technologies will be discussed further below.

In various embodiments of the invention, the collector module comprises an inertial impactor, including centrifugal impactors and bluff body impactors. Centrifugal impactors include “u-tubes” and concavoconvexedly curving channels in general. Bluff body impactors divert gas streamlines around an unstreamlined obstruction in the path of the gas stream. In other embodiments, the collector module comprises an electrostatic impactor.

Also disclosed are integrated detection and identification modules wherein a sampling duct is connected at a first end to a “tee” in the collector channel or particle trap and at a second end to a microfluidic assay circuit for further processing and analysis. In one embodiment, the particle trap is an integrated component of a microfluidic analysis circuit. In other embodiments, the particle trap is fitted with an optical window, lightpipe, lens flat, or waveguide for in situ analysis of said discrete liquid sample. In certain embodiments, a sacrificial layer of a soluble substrate is applied to the surfaces of the particle trap before use, so that by dissolving the sacrificial layer in an elution reagent, any aerosol particles captured on the surface of the sacrificial layer are released into the elution reagent. In situ analysis may be for screening purposes, so that samples can be tagged for more in-depth analysis subsequently. Liquid samples collected as described herein may be archived for later use. Apparatus and methods are disclosed, including combinations of aerosol collector modules with aerosol collector modules and liquid sample analysis modules.

The invention addresses the problem of collecting aerosol particles from large volumes of of air in very small particle traps, and eluting the captive sample material in very small volumes of a liquid reagent, thus achieving extremely high concentration factors relative to the dispersed aerosol and improving sensitivity and robustness of analyses of the captive aerosol particles and their constituents.

### BRIEF DESCRIPTION OF THE FIGURES

FIG. 1 is a schematic of a first collector module with particle trap.

FIG. 2 is a schematic of a second collector module with particle trap.

FIG. 3 is a schematic of a collector apparatus with centrifugal inertial impactor and droplet injection and elution mechanism.

FIGS. 4A-D illustrate a process of operating a collector apparatus having a centrifugal inertial impactor and on-board elution fluid reservoir.

FIG. 5A demonstrates the effect of collector channel diameter on particle capture at a gas flow rate of 0.5 L/min.

FIGS. 5B and 5C describe particle traps with radius of curvature R_{c} equal to one-half and two-thirds the internal diameter of the collector channel, respectively.

FIG. 6A demonstrates the effect of gas flow rate on particle capture in a larger collector channel.

FIG. 6B is a table showing the effect of collector channel diameter on volume of a particle trap.

FIG. 7A shows experimental data for recovery of bacterial cells in a centrifugal impactor using 500 nanoliter droplets of saline as an elution reagent.

FIG. 7B shows experimental data for recovery of bacillus spores in a centrifugal impactor using 500 nanoliter droplets of 0.1% Tween-20 as an elution reagent.

FIGS. 8A-D are four views of centrifugal impactor configurations.

FIG. 9A shows by dotted line the particle trap having features referenced in FIGS. 9B-D.

FIGS. 9B-D show embodiments of a centrifugal-impactor type particle trap configured with a microfluidic injector duct, injector/sampling duct, or tandem injector and sampling ducts with valving.

FIG. 10A shows a particle trap impactor configured with a injector/sampling duct and a sacrificial substrate overlayer lining the collector channel.

FIG. 10B shows a centrifugal-impactor particle trap configured with tandem injector and sampling ducts and having a regenerated sacrificial substrate overlayer lining the trap.

FIGS. 11A and 11B show a two-part diagram of a method for preparing a centrifugal-impactor particle trap with sacrificial substrate overlayer lining the trap.

FIG. 12 illustrates improvement in bacterial elution efficiency for E. coli using a sacrificial substrate overlayer.

FIG. 13 is a schematic representation of a collector channel with bluff body impactor.

FIGS. 14A and 14B show collection and elution of aerosol particles from a bluff body-type particle trap.

FIGS. 15A and 15B represent an alternative bluff body embodiment using tandem microfluidic ducts.

FIGS. 16A and 16B show collection and elution of aerosol particles from a bluff body-type particle trap, the bluff body having a sacrificial substrate overlayer.

FIG. 17 shows a modified bluff body member with sacrificial substrate overlayer on the impactor surface and embedded heating element.

FIG. 18 shows a bluff body member with impactor surface modifications for processing and treating an aerosol sample.

FIG. 19 is a schematic of a collector module with electrostatic impactor-type particle trap.

FIGS. 20A and 20B illustrate operation of an electrostatic particle trap.

FIG. 21 is a schematic view of an integrated aerodynamic lens (ADL) with skimmer and centrifugal impactor. The ADL is a multistage aerosol concentrator.

FIG. 22 depicts schematically an apparatus with integrated microfluidic particle trap and nucleic acid amplification and detection cartridge interfaced with a single stage ADL with skimmer and adaptor.

FIG. 23 shows how modular construction with a collector body of the invention can be used to build an aerosol analytic apparatus integrating various combinations of modules.

FIG. 24 shows how modular construction with a collector body of the invention can be used to build an aerosol analytic apparatus integrating a centrifugal particle trap.

FIG. 25 shows how modular construction with a collector body of the invention can be used to build an aerosol analytic apparatus integrating an electrostatic particle trap.

FIG. 26 is an example of a microfluidic card with integrated particle trap and microfluidic circuitry for amplifying and detecting a nucleic acid.

FIG. 27 is typical data showing nucleic acid amplification by PCR with real time detection by molecular beacon technology as applied to detection of an aerosol particle in a microfluidic cartridge having an integrated particle trap collector and associated microfluidic circuitry for PCR amplification of a nucleic acid.

### DETAILED DESCRIPTION

Although the following detailed description contains specific details for the purposes of illustration, one of skill in the art will appreciate that many variations and alterations to the following details are within the scope of the claimed invention. The following definitions are set forth as an aid in explaining the invention as claimed.

### DEFINITIONS

An “aerosol particle” is a generally diminutive or lightweight body of solid, liquid or gel-like matter suspended or dispersed in a gas volume. This can include, without limitation thereto, dust motes, exfoliated skin cells, fibers, spores, vegetative cells, mists, condensates, virus particles, bacteria, yeasts, mucous droplets, microdroplets of saliva and bronchial secretions, pollen grains, fly ash, smog condensate, smoke, fumes, dirt, fogs (as in industrial or agricultural spray application), salt, silicates, metallic particulate toxins, tar, combustion derived nanoparticles, particulate toxins, and the like. The aerosol particle may be a composite, containing both solid and liquid matter. Such particulate bodies can remain suspended in a column of air for long periods of time, can be carried on currents in the air, or can settle onto surfaces from which they may be resuspended by agitation.

Aerosol particles ranging from 0.01 to 25 microns are particularly hazardous. Particles less than 10 microns in apparent aerodynamic diameter pose a respiratory threat, and those less than 2.5 microns are of particular concern, as these can be inhaled deep into the lung. Aerosols include bioaerosols and particulate toxins.

Bioaerosols refer generally to aerosolized living cells and infectious lifeforms. Bioaerosols generally contain a nucleic acid. Many bioaerosols are smaller than 2 microns in aerodynamic diameter. Bioaerosols include bacterial cells, rickettsial elementary bodies, mycoplasma, spores, conidia, viruses, and other biowarfare or bioterrorism airborne agents. Bioaerosols may be hazardous because of infectiousness, toxicity or both. Airborne agents are detected as aerosolized particulates suspended in the air or as condensates which may be associated with particulate nuclei such as dust motes. Bioaerosols include Staphylococcus enterotoxin B), bacteria (including Bacillus anthracis, Brucella melitensis, Brucella abortus, Bordatella pertussis, Bordatella bronchioseptica, Burkholderia pseudomallei, Pseudomonas aeruginosa, Pseudomonas putrefaciens, Pseudomonas cepacia, Eikenella corrodens, Neisseria meningitides, Corynebacterium diptheriae, Fusobacterium necrophorum, Mycobacterium tuberculosis, Actinobacillus equuli, Haemophilus influenzae, Klebsiella oxytoca, Klebsiella pneumoniae, Legionella pneumophila, Listeria monocytogenes, Kingella denitrificans, Coxiella burnetii, Yersinia pestis, Pasteurella multocida, Vibrio cholera, Streptococcus pyogenes, Francisella tularensis, Francisella novicida, Moraxella catarrhalis, Mycoplasma pneumoniae, Streptococcus pneumoniae, Staphylococcus aureus, Vibrio cholera), Rickettsia (including Chlamydia pneumoniae, Chlamydia trachomatis, Rickettsia prowazekii, and Rickettsia typhi), and viruses (including Western Equine Encephalitis virus, Eastern Equine Encephalitis virus, Venezuelan Equine Encephalitis virus, Enteroviruses, Influenza virus, bird flu, Coronavirus, Adenovirus, Parainfluenza virus, Hanta virus, Argentine Hemorrhagic Fever virus, Machupo virus, Sabia virus, Guanarito virus, Congo-Crimean Hemorrhagic Fever virus, Lassa Hemorrhagic Fever virus, Marburg virus, Ebola virus, Rift Valley Fever virus, Kyasanur Forest Disease virus, Omsk Hemorrhagic Fever, Yellow Fever virus, Dengue virus, Smallpox virus, Monkeypox virus, and foot and mouth disease virus), among others, fungal agents such as Coccidiodes immitis, Candida albicans, Cryptococcus neoformans, and Aspergillus fumigatus, and may also include plant pathogens of economic significance such as citrus canker and rust viruses of grains. Such airborne agents may be weaponized with surface active excipients to better form an aerosol.

Particulate toxins, while not limited hereto, that may be encountered in aerosols include weaponized formulations containing a Botulinum toxin, Diptheria toxin, Tetanus toxin, Staphylococcal enterotoxin B, saxitoxin, tetrodotoxin, palytoxin, brevetoxin, microcystin, Trichothecene mycotoxins (eg. T2), diacetoxyscirpenol, nivalenol, 4-deoxynivalenol, cereulide, ricin, and Yersinia pestis F1 antigen, for example. Chemical toxins in particulate form such as tabun (GA), sarin (GB), soman (GD), cyclosarin (GF), and VX (methylphosphonothioic acid); blister agents such as sulfur mustard, nitrogen mustard, Lewisite, and phosgene oximine; choking agents such as phosgene, diphosgene, chlorine and chloropicrin, lacrimators such as chlorobenzylidenemalononitrile, chloroacetophenone, and nitrochloromethane; herbicides such as “agent orange” and Round-up® organophosphates, pesticides such Isotox®, Procure®, Fluvalinate, Imidacloprid, Coumaphos, Apistan®, CheckMite®, Aldicarb®, Neonicotinoids, Pyrethroids, and Gaucho®, for example, as may also be encountered in weaponized aerosols or in “fogs” and “mists” encountered in industrial and agricultural use.

“Aerosol”—refers to a population of small or lightweight bodies termed “aerosol particles” suspended or dispersed in a gas volume. Because an aerosol is composed of both a gas and a suspended or dispersed phase, care is generally taken to refer to “aerosol particles” when the suspended or dispersed material is referred to.

Aerodynamic Diameter—is defined as the diameter of a sphere of unit density (1 g/cm³) that attains the same terminal settling velocity (vₛ) at a low Reynolds number as the actual particle under consideration. For mathematical modeling purposes, it is convenient to express the behavior of an irregularly shaped particulate specimen as if it were a spherical particle, making it easier to predict, compare and correlate various materials. Typically, the density of a particulate sample is not known during field sampling and calculations are generally performed assuming unit particle density (1 g/cm³).

“Cut-off size”—is defined as the particle size for which 50% of the particles of that size class are captured on a particle trap impactor, generally an inertial impactor, of defined geometry under the specified conditions of operation.

“Aerosol concentrator module”: includes aerodynamic lens concentrators, aerodynamic lens array concentrators, and micro-aerodynamic lens array concentrators, when used in conjunction with a virtual impactor, skimmer or other means for separating a gas flow into a particle-enriched core flow (also termed “minor flow”) and a “bulk flow”, which is generally discarded. Also included are cyclone separators, ultrasound concentrators, and air-to-air concentrators generally for generating a flow split, where the “flow split” refers to the ratio of the minor flow to the bulk flow or total flow. The particle-enriched gas stream is delivered to an outlet of the aerosol concentrator module and may be conveyed to an aerosol collector module.

“Aerodynamic lens”—is a device having a passage for a gas stream characterized by constrictions (lenses) that have the effect of focusing the particle content of the gas into a core flow region or “particle beam” surrounded by a sheath of particle depleted air. An ADL can further be configured with a virtual impactor (also termed a “skimmer”) for separating the particle-enriched core flow (also termed “minor flow”) from the sheath flow (commonly termed “bulk flow”) which is generally discarded.

Skimmer—a virtual impactor device for separating a bulk flow from a particle-enriched core flow, generally used with an aerodynamic lens to form an aerosol concentrator.

“Particle trap”—as used here, refers to a microfluidic- or near-microfluidic sized element of a collector channel having the property of reversibly capturing aerosol particles by virtue of their inertia or their electrostatic charge. Particles are captured on a surface or surfaces of the particle trap, termed herein “impactor surface(s)”.

Inertial Impactor—a body or member having an impactor surface which is disposed in a gas flow such that streamlines of the gas flow are deflected around the impactor surface but particles with inertia exceeding the cut-off of the collector collide with the impactor and are preferably captured on it. As used here, inertial impactors of interest are of two classes, “centrifugal impactors” and “bluff body impactors”. Liquid impingers and plate impactors may be considered a sub-class of bluff body impactors.

“Centrifugal Impactor”—describes a family of impactors for capture of aerosol particles (ie. aerosol or aerosols) from the core of a streaming laminar flow of a gas, in which a channel for conducting the gas flow is bent or curves, forming a concavoconvex channel or passageway for the flowing gas. Where the concavedly curving inner wall intersects or impinges on the long axis of gas flow, inertial force will cause more dense aerosol particles to impact what is termed here the “inertial impactor surface” or “centrifugal impactor surface”, the area of the inside wall crossing or impinging on the long axis of flow. In a collector channel, an impactor surface is formed wherever an internal wall of the concavoconvex passage intersects or impinges on the long axis of gas flow, deflecting the gas streamlines. The channel geometry for an inertial impactor is generally tubular, with circular, ovoid, or rectangular cross-section.

“Bluff Body Impactor”—Inertial impactors are also formed by flowing a gas stream around an obstacle in the path of the stream so as to cause a sharp change in the direction of the gas stream. In some cases, the gas flow is “split” around the obstacle. The obstacle, which is termed a bluff body, is not streamlined. Higher momentum particles do not deviate with the gas stream and instead collide with the windward surface of the obstacle, termed here the “inertial impactor surface”. These impactors can include cascade impactors and liquid impingers.

“Electrostatic Impactor”—refers to a pair of capacitively electrified plates for capturing charged aerosol particles by impaction on the plates. The plates are thus “electrostatic impactor surfaces”. Positive and negatively charged plate surfaces attract and bind oppositely charged particles. Particles may be natively charged or may acquire charge by contact with a source of ions, such sources including but not limited to a “corona wire,” a source of ionizing radiation, or a radio-frequency discharge.

“Aerosol Collector Module”—refers to an apparatus or subassembly of an apparatus for collecting and eluting captured aerosol particles or constituents thereof in a microdroplet volume. Aerosol collector modules may contain inertial impactors, centrifugal impactors, liquid impingers, bluff body impactors, or electrostatic impactors. Fluidic systems are provided for microelution of the captured material as a liquid sample. The aerosol collector module is thus an “air-to-liquid” converter. Combinations of aerosol concentrator modules and aerosol collector modules are also “air-to-liquid” converters, having greater concentrative power than aerosol collector modules alone.

Inelastic collision—a collision with an impactor surface in which the colliding particle retains no kinetic energy after the collision, ie., the particle is captured on the impactor surface. Inelastic collisions may be irreversible or reversible.

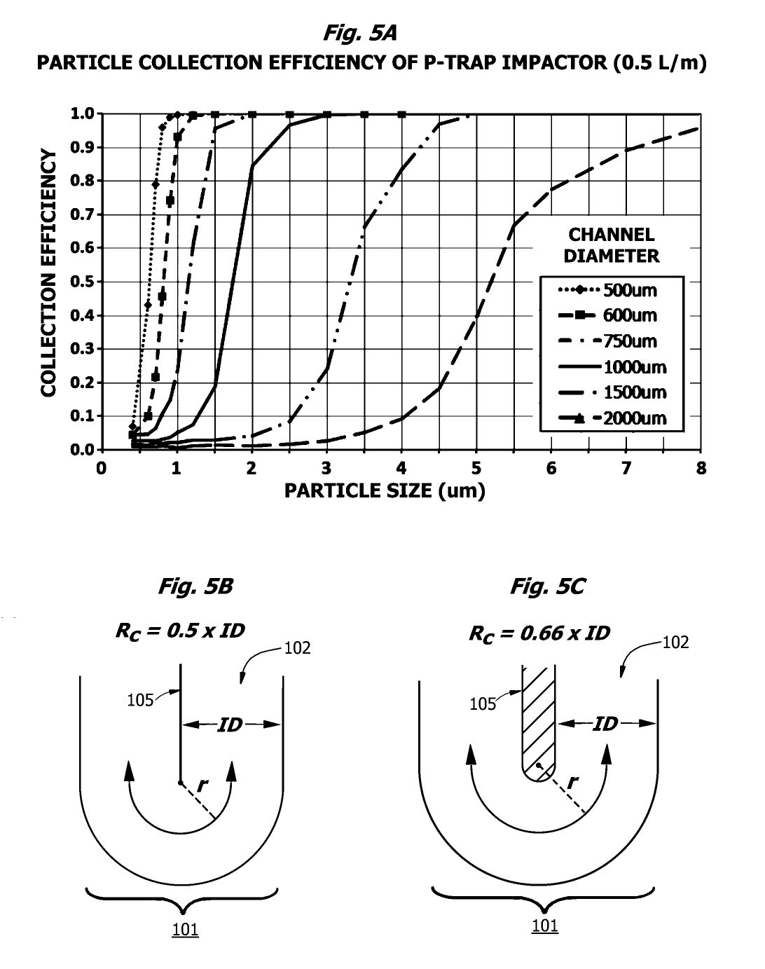

Radius of curvature—(R_{c}) or “bending radius” as defined here is taken along the centerline of a centrifugal inertial impactor and is generally in the range of greater than 0.5 to about three or ten times the characteristic dimension of the collector tube or channel. A radius of curvature of 0.5×ID, where ID is the “characteristic dimension” (height or internal diameter) of the channel, is not generally possible because the septum separating the arms of the channel at the bend would have no thickness. See also FIGS. 5B and 5C.

Elution—the meaning taken here is from the latin verb root “luere, to wash out”, and refers to a process in which a fluid is used to remove a substance from a location on which it is deposited—and to suspend, or solubilize, the concentrated substance in a liquid sample for analysis. To state that “the aerosol was eluted,” indicates that an aerosol deposited in a particle trap was then taken up as a concentrate in a volume of a fluid for analysis. Broadly, as used herein, elution can also refer to the related process of leaching, where a component of a deposited material is solubilized to form a liquid sample. We may refer to “micro-elution” to indicate that elution takes place preferably in a microvolume of a liquid.

Pump functionality—or member, refers to any utility for pumping a fluid, such as are commonly known in the art.

Microfluidic—by convention, an adjective referring to apertures, channels, chambers, valves, pumps, and other hydraulic components having a cross-sectional dimension of less than 500 microns. Here microfluidic and near-microfluidic features are taken as inclusive of features with a dimension less than 2 mm, more preferably less than 1 mm.

Microdroplet volume—refers to a discrete volume of a fluid, generally of 10,000 nanoliters or less. May also be termed a “microdroplet”, although such volumes are not limited to volumes in the form of free-falling “droplets” per se and are frequently confined in a channel or contacted with a surface.

Nanodroplet—refers to a discrete volume of a fluid, generally of 1000 nanoliters or less, more preferably a few hundred nanoliters. May also be termed a “nanodroplet volume”, although such volumes are not limited to volumes in the form of free-falling “droplets” per se and are frequently confined in a channel or contacted on a surface.

The prefix “micro-” generally refers to any component having a sub-millimeter-sized feature and any volume measured in microliters.

The prefix “nano-” generally refers to any component having a sub-micrometer-sized feature and any volume measured in nanoliters.

Glass—a wholly or partially amorphous solid having a glass transition temperature T_{g}: the temperature at which an amorphous solid, such as glass or a polymer, becomes brittle on cooling or soft on heating, and a melt temperature Tₘ. Below the glass transition temperature, T_{g}, amorphous solids are in a rigid glassy state and most of their joining bonds are intact. In organic molecules, particularly polymers, secondary, non-covalent bonds between the polymer chains become weak above T_{g}. Above T_{g} glasses and organic polymers become soft and capable of plastic deformation without fracture. Above Tₘ, the solid becomes a liquid. Preferred here are glasses that have a solubility in a liquid.

Means for amplifying—includes the “polymerase chain reaction” (PCR) which is described in detail in U.S. Pat. Nos. 4,683,195, 4,683,202 and 4,800,159; in Ausubel et al. Current Protocols in Molecular Biology, John Wiley and Sons, Baltimore, Md. (1989), and in Innis et al., (“PCR Protocols”, Academic Press, Inc., San Diego Calif., 1990). Polymerase chain reaction methodologies for nucleic acid amplification require thermocycling and are well known in the art. As means for amplifying also considered are isothermal amplification methods. By adding fluorescent intercalating agents, molecular beacons, and so forth, nucleic acid amplification products, known in the art as “amplicons”, can be detected as reaction endpoints or in real time.

Liquid sample analysis module—refers to an apparatus or subassembly of an apparatus having means for detecting an aerosol particle or constituent of an aerosol particle, and having the purpose of detection and/or characterization of the particle or constituent thereof.

Means for detecting—as used herein, refers to an apparatus for displaying and optionally evaluating a test endpoint, ie. the result of an assay. Detection endpoints are detected and evaluated by an observer visually, or by a machine equipped with a spectrophotometer, fluorometer, luminometer, photomultiplier tube, photodiode, nephlometer, photon counter, voltmeter, ammeter, pH meter, capacitative sensor, radio-frequency transmitter, magnetoresistometer, or Hall-effect device, and so forth. Magnifying lenses, optical windows, lens flats, waveguides, and liquid waveguides, may be used to improve detection.

Means for detecting may also include “labels” or “tags” such as, but not limited to, dyes such as chromophores and fluorophores; radio frequency tags, plasmon resonance, radiolabels, Raman scattering, chemoluminescence, or inductive moment as are known in the prior art. Fluorescence quenching detection endpoints (FRET) are also anticipated. A variety of substrate and product chromophores associated with enzyme-linked immunoassays are also well known in the art and provide a means for amplifying a detection signal so as to improve the sensitivity of the assay, for example “up-converting” fluorophores. Also comprising detection means are liquid chromatography (LC), high pressure liquid chromatography (HPLC), electrochemistry, polarography, electrochemical impedance spectroscopy (EIS), surface plasmon resonance (SPR), high pressure liquid chromatography with mass spectroscopy (HPLC/MS), fast atom bombardment spectroscopy (FABS), matrix-assisted laser desorption ionisation mass spectrometry (MALDI/MS), inductively coupled plasma mass spectroscopy (ICP/MS), gas chromatographic mass spectroscopy (GC/MS), Raman spectroscopy (RS), surface-enhanced Raman spectroscopy (SERS), laser induced breakdown spectroscopy (LIBS), spark-induced breakdown spectroscopy (SIBS), lateral flow chromatography, and so forth. Detection systems are optionally qualitative, quantitative or semi-quantitative. Detection means can involve visual detection, machine detection, manual detection or automated detection.

Unless the context requires otherwise, throughout the specification and claims which follow, the word “comprise” and variations thereof, such as, “comprises” and “comprising” are to be construed in an open, inclusive sense; that is, as “including, but not limited to”.

Reference throughout this specification to “one embodiment” or “an embodiment” means that a particular feature, structure or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

### Collector Module for Micro-Elution of Captured Aerosol Particles

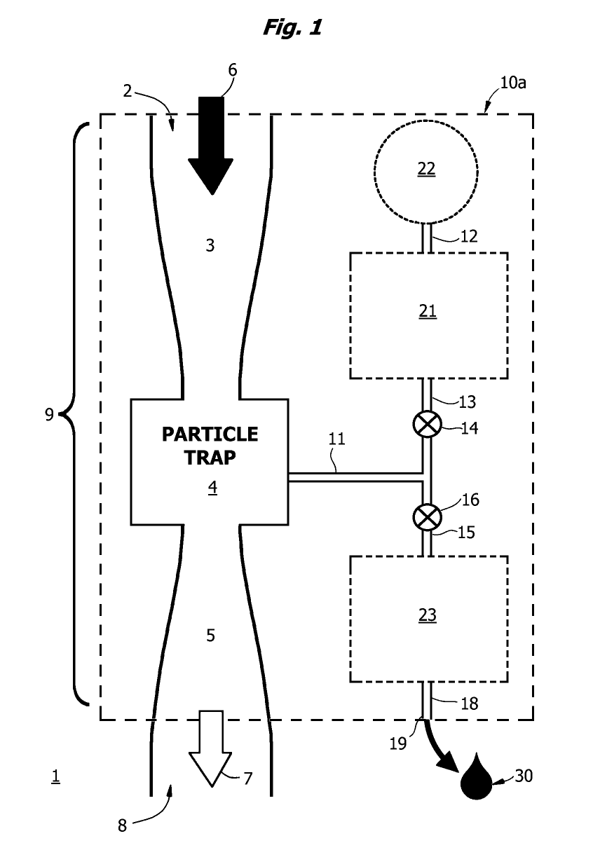

Turning now to the figures, FIG. 1 is a generic schematic of a collector module 10a for micro-elution of captured aerosol particles. Shown in block form are the functional components of a first embodiment of a particle collection and elution apparatus 1. A particle trap (block 4) is disposed in a collector channel 9, the collector channel, represented here figuratively, consisting of a receiving arm 3 with intake orifice 2 and an outlet arm 5 with outlet orifice 8. A gas stream 6 with aerosol particles enters the collector channel through the intake orifice and transits the particle trap 4. The particle trap may be an inertial impactor, such as a centrifugal inertial impactor or a bluff body impactor, or may be an electrostatic impactor. The gas stream 7, depleted of particles, exits the collector channel 9 at the base of the module through outlet orifice 8. Aerosol particles accumulate as a mass or sample in the particle trap.

The elution apparatus of module 10a comprises a pump functionality or member (block 21) with associated fluid reservoir 22. The functional components of apparatus 1 with dotted outlines may be mounted within module 10a or may optionally be mounted externally and associated through fluidic connections with module 10a. Fluid from reservoir 22 is injected via microfluidic ducts 13 and 11, optionally with valve 14, into particle trap 4, in the form of a discrete microdroplet volume. Microfluidic duct 11 is termed a microfluidic injection duct. Generally the volume injected is small, and may be less than 10,000 nanoliters, more preferably less than 1000 nanoliters. In the particle trap, the microdroplet volume is contacted with the impactor surface or surfaces of the trap and captive aerosol sample is eluted in the confined structure of the particle trap 4, thereby forming a liquid sample.

The reagent fluid reservoir 22 may be contained in the collector module, or may be in fluidic communication with the injection duct 11 and pump functionality or member 21 but mounted externally.

Reagent fluids include elution reagents, analytical pre-processing reagents, and detection reagents. Elution reagents are formulated to resuspend and solubilize the captured aerosol particle mass. These reagents are generally aqueous, but may include co-solvents such as dimethylsulfoxide, N,N-dimethylformamide, N-methyl-pyrrolidinone, 2-pyrrolidone, acetone, Transcutol® (Gattefosse, FR), acetonitrile, acetone, methylethylketone, methyl tert-butyl ether (MBTE), tetrahydrofuran, and so forth. The co-solvent is generally miscible with water but if not may be formulated as an emulsion or micro emulsion or used without water. Surfactants and wetting agents as are generally known in the art are also suitable for formulation in an elution reagent. Such surfactants may include Tween 20, Brij-72, Triton X100, Pluronic F68 (BASF, Florham Pk, N.J.), n-acyl-glutamate (Amisoft®, Ajinomoto, JP), Envirogem® 360 (Air Products, Allentown Pa.), Eccoterge® AEP-20 (Eastern Color, Providence R.I.), sodium lauryl sulfate, and so forth. A more comprehensive list of surfactants, co-surfactants and wetting agents may be found in McCutcheon's Emulsifiers and Detergents (2008 Edition). Also useful for eluting biological samples are salts and buffers. Analytical pre-processing reagents include for example chaotropic salts or urea, such as described by Boom (U.S. Pat. No. 5,234,809), or alkaline SDS lysis solution containing 200 mM NaOH and 1% SDS, as are known to aid in the lysis of bacterial cells, and also enzymes such as lysozyme, chitinase or mucopolysaccharidases. These reagents serve to prepare the sample in situ for analysis and to release any bioaerosol material from a sample matrix. Detection reagents include antibodies, probes in general, nucleic acid intercalating agents, chromogenic reactants, dyes, hydrogen peroxide for detection of catalase, NADH or NADPH for the detection of dehydrogenases, ATPases, pyrophosphatases, and so forth.

Reagents can be injected into the device in sequence, for example an elution reagent can be injected first, followed by an analytical pre-processing reagent, followed by a detection reagent, or other permutations as are effective in achieving the desired result. In some cases, one reagent serves multiple functions. In some instances, a dry reagent can be placed in the collector channel or particle trap prior to collection of a sample, having the purpose of later being rehydrated by contact with a liquid reagent so as to react with the aerosol sample or a constituent of the sample. While not limiting thereto, dry reagents include a hydrolytic enzyme such as lysozyme or chitinase for digesting a sample, a chromogenic or fluorogenic dye such as ethidium bromide or tetrazolium blue for staining a sample, or an antibody with fluorescent probe conjugate, for example.

Microelution of aerosol particles by dispensing an elution reagent onto the impactor surfaces as provided in the present invention is achieved by any of several species of small pumps or pump functionalities which can deliver fluids through microfluidic channels at very low volumetric flow rates and useful linear velocities. These micro-pumps include piezoelectric dispensors, inkjet printer heads generally, positive displacement pumps, syringe pumps, microfluidic diaphragm pumps, magnetostrictive diaphragm pumps, electrowetting devices, thermopropulsive pumps, Gibbs-Marangoni devices, and hybrid devices such as piezoelectric dampeners or diffuser-nozzle heads on a syringe pump. Also contemplated are binary droplet devices.

In one embodiment, piezoelectric microdispensors such as are known in the inkjet printing industry are used to inject measured volumes of a fluid onto the impactor surface. The dispensers are compatible with a broad range of liquids from acetonitrile to 7M urea and have good solvent resistance. Because the responses to a voltage across a PZT wafer, for example, are very reproducible, extremely precise microdroplets or nanodroplets are expelled with each current pulse, which can be supplied as a square wave across the wafer electrodes. By supplying fluid from a reservoir to the pump body, the process can be repeated indefinitely, and results in a stream of droplets. The dispensers thus act as pumps. The volumes achievable are micro-, nano-, and subnano-liter sized droplets. By joining a pair of piezoelectric microdispensors to a common aperture, filling only one with a fluid and then activating the dispensers in alternation, a train of droplets separated by bubbles can be dispensed. Single aperture and multi-head devices of 3 mm OD or less are readily obtained in OEM configurations (Gesellschaft Silizium Mikrosysteme mbH, Groserkmannsdorf DE), for example.

Inkjet printer heads suitable for the present invention also include “Micro Piezo” MEMS microtechnology developed by Seiko Epson (Tokyo JP). See for example US Patent Applications 2007/0007860 and 2007/0048191. Newer PZT films used in the ink cavities have a displacement of 400 nm depthwise per 55 micron cavity width, acceptable for the requirements of the current invention. Also of interest are bubblejet printer heads described in U.S. Pat. Nos. 6,561,631 and 6,926,386 to Shin. The resulting inkjet heads are so small that it becomes feasible to embed the printer head in the collector module body or in a microfluidic channel in fluid communication with the collector channel, as will be discussed further below.

Piezoelectic actuators may also be used to control syringe pumps to produce the required microvolume flow. Kar (Kar, S et al. 1998. Piezoelectric mechanical pump with nanoliter per minute pulse-free flow delivery for pressure pumping in microchannels. Analyst 123:1435-1441) discloses diffuser/nozzle heads capable of adapting a syringe pump for continuous flow of nanoliter volumes without need for reloading the syringe pump. Syringe pumps, diaphragm pumps, and positive displacement pumps more generally, can be adapted to pump microvolumes of a fluid and can be installed or formed in the collector body or positioned remotely with fluidic connections to the collector channel and to a reagent reservoir.

Magnetostrictive pumps for handling nanoliter volumes are known. Examples are disclosed in U.S. Pat. Nos. 4,795,317, 4,795,318, 4,815,946, 5,129,789, and 7,316,336. U.S. Pat. No. 7,316,336 to Kaartinen is assigned to Fluilogic Oy (Espoo, Fla.); Fluilogic's Electromagnetic Bellows (EMB) Pump Module is distributed by ViaFlo (Hudson, N.H.) and has no seals or moving parts, dispensing discrete volumes 10 nanoliters to 1450 microliters per actuation and is thus well suited for incorporation in the devices and apparatus of the present invention.

Small pneumatic and electric diaphragm pumps adapted for microfluidic circuits are also known, as for example disclosed in U.S. Pat. No. 5,836,750 (therein termed “mesopumps”) and U.S. Pat. No. 6,729,856 and US Patent Application 2007/014522. Passive pumping systems such as by capillary action, bibulous wetting, and so forth are also contemplated.

Thermopropulsive differential heating can also be used to propel microdroplets in microfluidic channels, as described by Handique in U.S. Pat. No. 6,130,098.

“Electrowetting”, in which small currents are passed through a droplet containing a conducting ion, is also suitable as a means to propel a droplet, and is a well known and established technology, for example as illustrated in U.S. Pat. No. 6,174,675 to Chow, U.S. Pat. No. 6,749,407 to Xie, and U.S. Pat. Nos. 6,565,727, 6,773,566 and 7,255,780 to Shenderov. This principle forms the basis of fluidic pumps and valves under development by Advanced Liquid Logic (Research Triangle Park N.C.).

In another aspect of the invention, the microfluidics of the microdroplet in the collector channel or on the surface of the impactor is controlled by electrical voltage pulses applied to a grid of electrodes embedded under a hydrophobic dielectric surface. Droplets have been shown to move from lower voltage to higher voltage in the range of 40 to 300 V, as described by Pamula in U.S. Pat. No. 6,911,132 and US Patent Applications 2006/019433 and 20070267294. The force acting on the liquid is a potential-dependent gradient of adhesion energy between the liquid and a solid insulating hydrophobic surface. The operating principle of the devices is a modification of “electrowetting” but avoids electroconduction in the sample liquid. If a droplet of polar liquid is placed on a hydrophobic surface, application of an electric potential across the liquid-dielectric interface reduces the contact angle, effectively converting the surface into an area of lower free surface energy toward which the droplet moves. A droplet of a polar liquid will seek out the lowest free surface energy (also termed the most “hydrophilic surface”) and move toward it so as to maximize the contact area overlap with the electric field.

A particle trap having embedded circuit elements or an impactor surface having a microchip treated with a silane such as parylene, a perfluoromer such as Teflon®, a polyxylene polymer such as Lotusan® (Sto Corp, Atlanta Ga.) are suitable for demonstration of this effect, which can be adapted to move a microdroplet along the surface of the impactor, eluting impacted particles like a sticky roller, for example. By design of a track of closely spaced electrode pairs, each activated in turn, a droplet can be rapidly moved across the impactor surface and then collected or analyzed as preferred.

The tendency of a fluid to move to reduce the free energy of interfacial tension has been termed the “Gibbs-Marangoni effect” (the mass transfer of a fluid on or in a liquid layer along a surface tension gradient) and we thus term these devices “Gibbs-Marangoni devices”, which include binary droplet devices such as described by Bico and Quere (Bico, J and D Quéré. 2002. Self-propelling slugs. Journal of Fluid Mechanics, 467:101; Bico J and D Quéré. 2000. Liquid trains in a tube. Europhysics Letters, 51:546).

Applying a pressure differential across the collector channel is one simple approach that can be accommodated by providing a suction pressure to a sampling duct in fluidic communication with the collector channel and particle trap. Pressure in the collector channel may be used to draw or push fluid onto the small impactor surface. Thus, also within the sense of “pump functionality” is any application of suction pressure, hydraulic pressure, or pneumatic pressure.

While not shown, pump functionalities may be bidirectional and self-priming, thereby eliminating the need for two pumps. A single, bidirectional pump functionality may be used to both inject a liquid reagent and withdraw a liquid sample from particle trap 4.

Microfluidic valves are also known in the art. Fluid flow may be unidirectional or bidirectional through valves or channels. Microvalves and checkvalves are known and may be adapted to control fluid direction and switching. These include ball valves, pinch valves, drum valves, flap valves, and peanut valves. Such valves and pumps are described in U.S. Pat. Nos. 5,498,392, 5,304,487, 5,296,375, 5,856,174, 6,180,372, 5,939,312, 5,939,291, 5,971,355, 5,863,502, 6,054,277, 6,261,431, 6,240,944, 6,418,968, 6,431,212, 6,440,725, 6,581,899, 6,620,273, 6,729,352, 6,748,975, 6,767,194, 6,901,949, 6,901,949, 5,587,128, 5,955,029, 5,498,392, 5,639,423, 5,786,182, 6,261,431, 6,126,804, 5,958,349, 6,303,343, 6,403,037, 6,429,007, 6,420,143, 6,572,830, 6,541,274, 6,544,734, 6,960,437, 6,762,049, 6,509,186, 6,432,695, 7,018,830, US Patent Applications 2001/0046701, 2002/0195152, 2003/0138941, 20050205816, and International Patent Publications WO1994/05414, WO 2003/004162, WO2002/18823, WO2001/041931, WO1998/50147, WO1997/27324, and so forth, which taken cumulatively describe various microfluidic devices for fluid processing and analytical operations. These microfluidic fluid control devices are well suited for incorporation in the collector modules and associated particle collection apparatus of the present invention and for directing and controlling elution, pre-processing or detection fluid reagents injected into and liquid sample withdrawn from the collector.

Returning to FIG. 1, the elution apparatus of module 1 further comprises a second pump utility or member 23 and associated microfluidic circuitry for conveying a liquid sample 30 to a sample port 19. The liquid sample contains any eluted aerosol particles or constituents thereof in the microdroplet volume injected into the particle trap. The liquid sample may be a suspension or a solution of the captured aerosol particles or constituents thereof.

The liquid eluate in the particle trap is conveyed via microfluidic ducts 11 and 15, with optional valve 16, to sampling duct 16, where liquid sample 30 is delivered at sample port 19 for analysis or archiving.

As will be discussed further below, delivery of a liquid sample to sample port 19 is optional; analysis may occur in situ prior to delivery, or may substitute for delivery of the liquid sample from the collector module.

Downstream analysis may be by physical, chemical, biochemical or molecular means for analysis. Samples collected from the collector module may optionally be archived in individual containers for that purpose, or stored in the collector module. Using networks of microfluidic channels, sample pre-processing by reagent addition may be performed continuously or in batch mode. With increased complexity, sample collection devices may be fabricated with partial or full integration of detection and/or identification capabilities, as will be discussed further below.

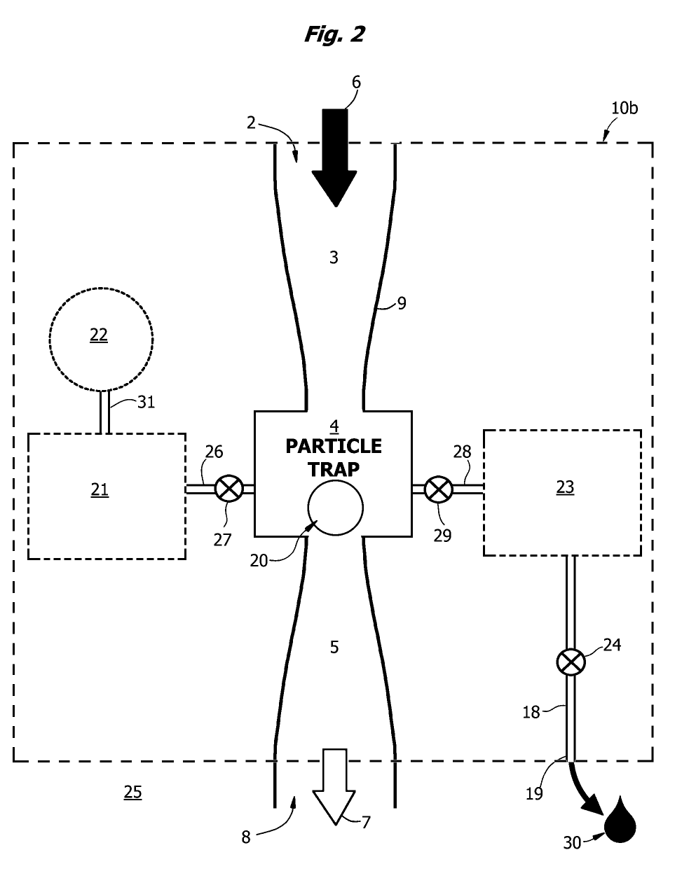

Turning now to FIG. 2, a second generic schematic of an aerosol collector module 10b for micro-elution of captured aerosol particles. Shown in block form are the functional components of a second embodiment of a particle collection and microelution apparatus 25. A particle trap (block 4) is disposed in a collector channel 9, the collector channel, represented here figuratively, consisting of a receiving arm 3 with intake orifice 2 and an outlet arm 5 with outlet orifice 8. A gas stream 6 with aerosol particles enters the collector channel through the intake orifice and transits the particle trap 4. The particle trap may be an inertial impactor, such as a centrifugal inertial impactor or a bluff body impactor, or may be an electrostatic impactor. The gas stream 7, depleted of particles, exits the collector channel 9 at the base of the module through outlet orifice 8. Aerosol particles accumulate as a mass or sample in the particle trap.

The elution apparatus of module 10b comprises a pump functionality or member (block 21) with associated fluid reservoir 22. The functional components of apparatus 25 with dotted outlines may be mounted within module 10b or may optionally be mounted externally and associated through fluidic connections with module 10b. Fluid from reservoir 22 is injected via microfluidic ducts 31 and 26, optionally with valve 27, into particle trap 4, in the form of a discrete microdroplet volume. Microfluidic duct 26 is termed a microfluidic injection duct. In the particle trap, the microdroplet volume is contacted with the impactor surface or surfaces of the trap and captive aerosol sample is eluted in the confined structure of the particle trap 4, thereby forming a liquid sample.

The liquid sample may be either analyzed in situ, treated for further analysis in situ, or delivered for downstream analysis. For in situ interrogation of the sample, an optical or acoustic window 20, lens flat, or waveguide in the collector body is optionally provided. Techniques that may be used to interrogate the liquid suspension include fluorescence, light absorption, and light scattering measurements of the liquid sample containing the eluted particles inside the collector, for example. Optical or acoustic window 20 may also be used to interface the collector body with an ultrasound transducer so that the liquid sample may be treated to disrupt and release its contents for analysis. The ultrasonic transducer, typically a PZT crystal laminate, may be integrated into the collector body in one embodiment.

For delivery of the liquid sample for downstream analysis, optional pump functionality or member 23 is provided. Sampling ducts 28 and 18, with optional valves 29 and 24 are used to convey the liquid sample from the particle trap to a sampling port 19, where liquid sample 30 is delivered for analysis or archival storage.

Other combinations are conceived. The liquid sample, for example, may be conveyed from the collection module via outlet arm 5. While not shown, pump functionalities may be bidirectional and self-priming, thereby eliminating the need for two pumps. A single, bidirectional pump functionality may be used to both inject a liquid reagent and withdraw a liquid sample from particle trap 4.

Alternatively, the treatment or analysis of the liquid sample may require introduction of additional reagents and the use of additional pumps. These techniques may require more sample manipulation (thermal cycling, mixing with additional reagents, and so forth). A microfluidic network with valve, channels and pumps to conduct these reactions may be incorporated in the collector module or as part of an associated apparatus. A branched microfluidic pathway may be provided so that air bubbles may be interjected between a train of microdroplets. A downstream debubbler may be desired to separate the liquid sample from any injected air, and so forth. Various embodiments containing inertial impactors and electrostatic impactors will be described in more detail below.

### Methods of Use

The apparatus of FIGS. 1 and 2 are essentially representative devices for accomplishing a series of steps and can be described by listing the series of steps performed by the device or apparatus. The cycle of steps may be repeated. Thus in another aspect, the invention is a method. The method can be described in general terms as: (i) directing a concentrated gas stream of aerosol particles through a collector channel, (ii) deflecting that gas stream (inertially or electrostatically) so that aerosol particles are impacted and adhere to an impactor surface, (iii) periodically eluting the aerosol particles from the surface in a liquid sample by contacting a small liquid droplet volume or a series of droplet volumes with the impactor surface, (iv) optionally conveying the resuspended or solubilized aerosol particles to a sampling port for analysis, v) optionally preparing the liquid sample for analysis by treating the liquid sample in situ, and/or vi) optionally analyzing the liquid sample in situ.

The first step is to deliver concentrated aerosol particles to a collector. A complete sampling system may include an upstream aerosol concentrator module incorporating a virtual impactor and aerodynamic lens, or other air-to-air concentratior, and an adapter for sealedly connecting the concentrator module to the downstream collector.

The second step is to impact the particle beam on an impactor so that the particles are captured on the impactor surface. Either centrifugal inertial impactors, bluff body impactors, or electrostatic impactors may be used for this purpose. These will be discussed in more detail in sections below.

The third step is to inject a small (ie. nanoliter- to microliter-sized) droplet into the collector channel and contact it with the impactor surface or surfaces so that the droplet effectively scavenges the deposited particles (or their chemical constituents) from the collection surface.

Approaches for particle microelution from the impactor surface in an elution droplet include surface modification to alter the surface energy of the collector walls, use of elution fluids containing surfactants, co-surfactants, wetting agents, solvents, co-solvents, or dissolution reagents to enhance the release of particles from the collector walls, or use of an ultrasonic field can be used to assist in dislodging the particles from the collector walls.

The collector module bodies of the present invention are readily adapted to be interfaced with a small transducer horn of an ultrasound generator, for example. For biological aerosols in situ lysing is possible via physical, electrical, chemical or thermal treatment of the organisms to release their DNA/RNA.

Dissolution of the aerosol particle to release a constituent, can be achieved, for example, with a chaeotrope such as guanidinium HCl or concentrated urea, optionally with a surfactant such as sodium dodecyl sulfate (SDS) and alkali. Chemical compounds and toxins of non-biological origin in an aerosol [for example excipients used to weaponize a bioaerosol] can be eluted for analysis by using a solvent such as methanol or acetone (for gas chromatography), aqueous ethanol or acetonitrile (for liquid chromatography), or acid (for inductively coupled plasma mass spectroscopy) as the elution and transport liquid, for example.

Optionally the method can comprise a step in which the liquid sample is conveyed to a sampling port for downstream analysis or archiving. Pump functionalities previously discussed may be used for this purpose.

Optionally, the method can comprise performing a pre-processing step for preparing the sample for analysis, for example by lysis of microbial cells or by release of nucleic acid, or by dissolving a sample matrix such as a mucous particle. Various optional chemical or physical pre-processing treatments are envisaged, including thermal treatments, ultrasonic treatments, particle digestion treatments, hydrolysis treatments, and so forth. These treatments can comprise a chemical treatment contacting said aerosol particle with a second reagent having the purpose of chemically modifying a constituent of the liquid sample; a thermal treatment or an ultrasonic treatment having the purpose of eluting or lysing the captured aerosol particle in the liquid sample; a radiological treatment with microwave or other radiation treatment having the purpose of lysing any captured aerosol particle in the liquid sample; a mechanical treatment with mechanical manipulation (such as mixing or moving) of a liquid sample with captured aerosol particle within the collector channel, in short treatment means for preparing the sample for analysis or for performing pre-analytical processing steps.

Optionally, a step for in situ detection may be employed. In one instance, a biochemical, physical, or molecular characterization of the recovered aerosol contents is undertaken in situ. Various means for detecting a particle or particle constituent are used for this purpose. This may involve determining whether a measurable characteristic of a sample exceeds a threshold value before subjecting the liquid sample to more thorough analysis. A screening step, as would differentiate a sample that is a potential threat from a sample that is a non-threat, is also contemplated in the invention. Analytical procedures can involve various technologies, and include without limitation steps for:
1. inducing fluorescence of specific constituents of the liquid suspension, detecting emitted fluorescent radiation, having the purpose of identifying those constituents of interest based on the spectrum of the emitted light;
2. measuring optical absorption of the liquid suspension at various wavelengths; having the purpose of identifying those constituents of interest, such as tryptophan, NADH or Vitamin B, based on the spectrum of the absorbed light;
3. measuring light scattered from the sample in various directions; having the purpose of quantitating or identifying those constituents of interest based on the spectrum of the scattered light;
4. subjecting the sample to nucleic acid amplification and real-time PCR; having the purpose of identifying those constituents of interest based on the fluorescence of a molecular beacon or probe;
5. subjecting the sample to an immunological assay; having the purpose of identifying those constituents of interest based on an antigen:antibody reaction; and/or,
6. subjecting the sample to at least one spectroscopic measurement technique such as

Raman spectroscopy (RS), surface-enhanced Raman spectroscopy (SERS), laser induced breakdown spectroscopy (LIBS), spark-induced breakdown spectroscopy (SIBS), surface plasmon resonance (SPR), or methods using fluorescence of particle constituents, having the purpose of identifying those constituents of interest.

This process of analysis may also involve a step for saving the droplet or droplets, or a part thereof, in a container or an array of containers for later analysis. In one instance, the collector is a disposable module and is removed from the apparatus and transported or saved for analysis off line.

More generally, the method may involve either a) releasing the particles into a liquid to form a suspension, or b) releasing all or some constituents of the aerosol particle, airborne agent, or excipient therein, into a liquid volume to form a solution, and then either a) analyzing the collected liquid sample inside the collector or b) transporting the liquid sample to an off-line detector for further analysis.

Once the aerosol sample, or the desired chemical or biological constituents of the sample, is solvated in the liquid droplet they can be processed in a number of ways. These include steps for:
1. optionally pre-processing the sample fluid in preparation for a subsequent detection step;
2. optionally performing an in situ analysis;
3. optionally performing an in situ assay for detecting a signal above a threshold level that will trigger further analysis;
4. optionally conveying the droplet via a sampling port and pumping means to a detector in fluidic communication with the collector body and performing an analysis downstream;
5. optionally analyzing the liquid sample in an integrated device, the device comprising the collector and a microfluidic circuit with on-board analytical module or modules such as a self-contained microfluidic circuit for performing PCR on nucleic acid extracted from the liquid sample or for performing an ELISA assay on constituents of the liquid sample;
6. optionally archiving the liquid sample, or a part thereof, in a container or an array of containers for later reference; and/or,
7. optionally delivering the entire collector assembly as a aerosol collector module containing the liquid sample to an off-line detector.

The analysis of the captured aerosol particles may be performed inside or outside the collector. The captured aerosol contents may be interrogated in liquid suspension or solution in situ or conveyed to a downstream site for analysis. Techniques that may be used to interrogate the liquid suspension include fluorescence, light absorption, and light scattering measurements of the liquid sample containing the eluted particles inside the collector. An optical window, lens flat, or waveguide in the collector body is provided for this purpose. The detection and analysis of the eluted sample may be performed downstream of the collector by a number of methods which require delivery of aerosol or its chemical constituents in liquid solution or suspension, for example surface plasmon resonance, high performance liquid chromatography/mass spectrometry (HPLC/MS), FABS, ICP/MS (Perkin-Elmer), GC/MS, and so forth. PCR, nucleic acid amplification, antibody techniques, and molecular biological, immunobiological techniques and other means for detection more generally may also be used.

### Centrifugal Inertial Impactors

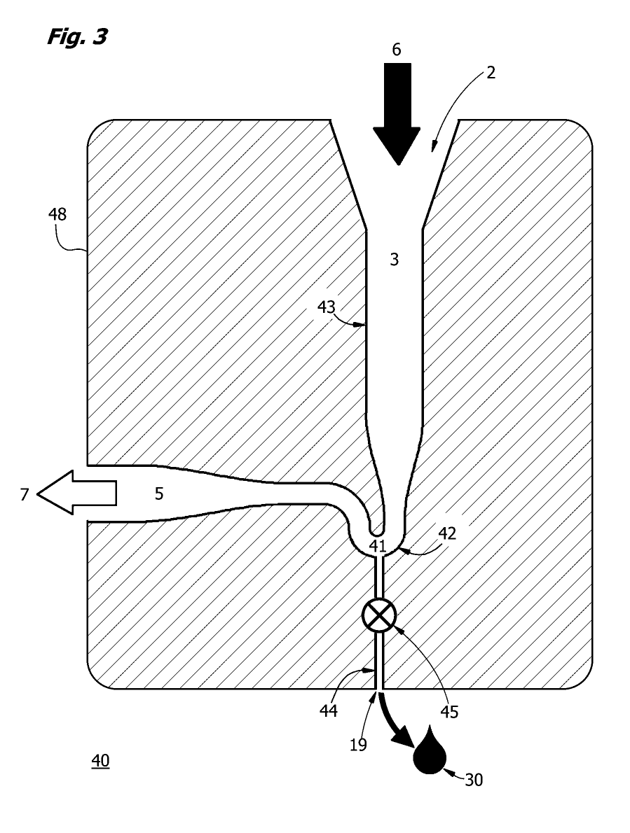

FIG. 3 is a schematic of an embodiment 40 of a collector apparatus or module of the invention, where the particle trap 41 is configured as a “centrifugal inertial impactor” having impactor surface 42. While not limited thereto, the collector module 40 is shown as having a plastic solid body 48.

Collector body 48 contains or encloses a collector channel 43 consisting of intake orifice 2, receiving arm 3 and outlet arm 5. A gas stream 6 flows through the collector channel in response, for example, to a suction pressure applied to the outlet arm. Disposed in the collector channel is inertial impactor 42, formed here by a concavoconvex “trap-like” curvature of the collector channel.

In operation, a gas stream 6 with entrained aerosol particles enters the collection channel at the top of the collector body. Aerosol particles not deflected with the gas streamlines in the bending portion of the channel are captured by inelastic impaction on the inertial impactor surface 42. The aerosol-depleted gas stream 7 or “bulk flow” exits the collector body at outlet arm 5. A liquid reagent injected through injection duct 44 and valve 45 contacts and elutes any deposited aerosol particles or constituents thereof in particle trap 41. The resultant liquid sample, containing a solution or suspension of the aerosol particles, is optionally analyzed or treated in situ or is conveyed to an external microfluidic circuit or other analytical means via a sample port 19.

As shown, injection duct 44 joins the collector channel at an injection port (46) or “tee” in the particle trap. It may be preferable to locate the tee downstream from or upstream of the impactor surface. The tee is generally proximate to the inertial impactor surface.

To collect the liquid sample, if desired, an auxiliary pump may be used, or the pump utility may be configured to be bidirectional. In another embodiment, the sample liquid 30 can be conveyed under differential pressure out of the collector body through outlet arm 5. During the sampling process, the gas stream and suction pressure is turned off or redirected using valves or stopcocks. Liquid sample 30 may be analyzed or retained for future analysis. Alternatively, the highly concentrated sample liquid can instead advantageously be analyzed in situ in the collector channel with a suitable analytical apparatus, such as spectroscopic analysis of the sample via an optical window in the collector body.

The collector channel 43 and particle trap 41 are designed so that collision with the impactor surface 42 is substantially an inelastic collision. General expressions for the mathematics of inertial particle impact are well known (see Hinds, W C, “Aerosol Technology: Properties, Behavior and Measurement of Airborne Particles”, 1982, Wiley-Interscience). Slip coefficients may be used for calculating cut-off parameters for sub-micron particles. Cut-off size is a useful parameter in comparing inertial impactors. In the collectors of the present invention, we achieve “cut-off sizes” of less than 0.5 microns aerodynamic diameter and sampling flow rates in the range of 0.05 to 10 L/min range, depending on the size of the channel and the application. While this discussion is directed principally to channels with a characteristic dimension of less than 1500 microns, we have also seen that the width of the channel, in the case of a rectangular channel for example, permits flow rates to be increased without modifying the physics substantially.

Collector module 40 can be fabricated by a number of methods, including carefully bending glass capillaries or plastic tubing, by molding mating halves of a plastic body, by lamination of stenciled and laser-cut films, or by what is termed three-dimensional photolithography, in which shapes containing internal structure are built layer-by-layer by laser-patterned photoactivated polymerization of a liquid monomer. The collector channel may be round or rectangular in cross section. In some instances the collector channel is a bent glass capillary impactor. Fabrication of a micro-U-tube of a glass capillary requires achieving a small radius of bending without breaking the capillary or collapsing its inner bore. Good results for bending fused silica capillary are obtained using a technique reported for fabricating a capillary spectrometer vessel (as described in U.S. Pat. No. 5,469,061 to Linehan). The bending is accomplished by holding the capillary upright, slightly inclined from plumb, heating the capillary with a torch, and letting it bend due to the force of gravity. This method produces tight, repeatable bends, for example a capillary (300 microns ID/665 microns OD) can be bent with heating into a U-shape with a radius of curvature of about 1 mm (R_{c}=0.66×ID, where ID is the internal diameter). The capillary does not collapse in the process and can optionally be potted in an epoxy collector body after fabrication. Another approach is to use plastic tubing bent in around a cylindrical peg in a jig. In a preferred method of fabrication, molded parts with mating female “half-channel” or recessed features are joined together to form the collector channel and associated microfluidic ducts.

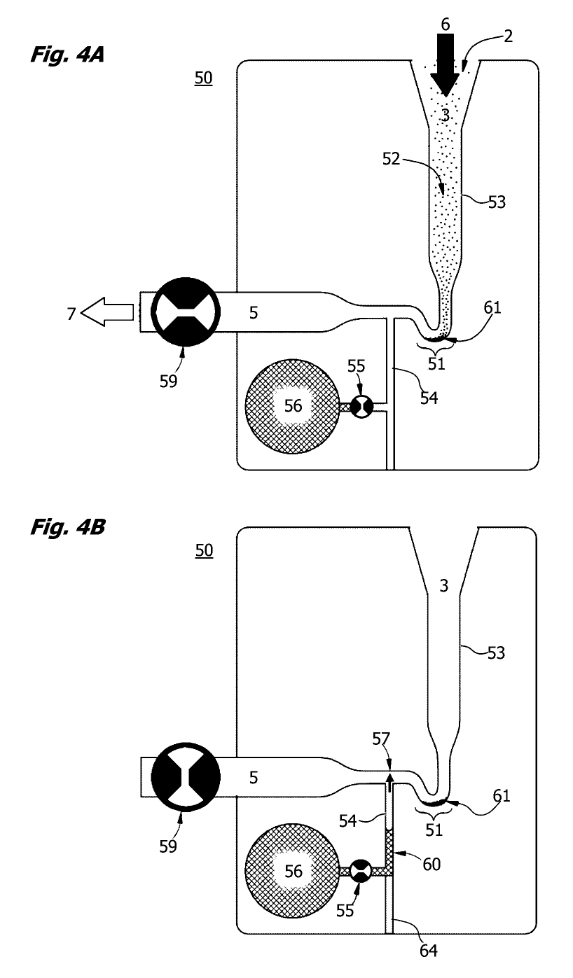

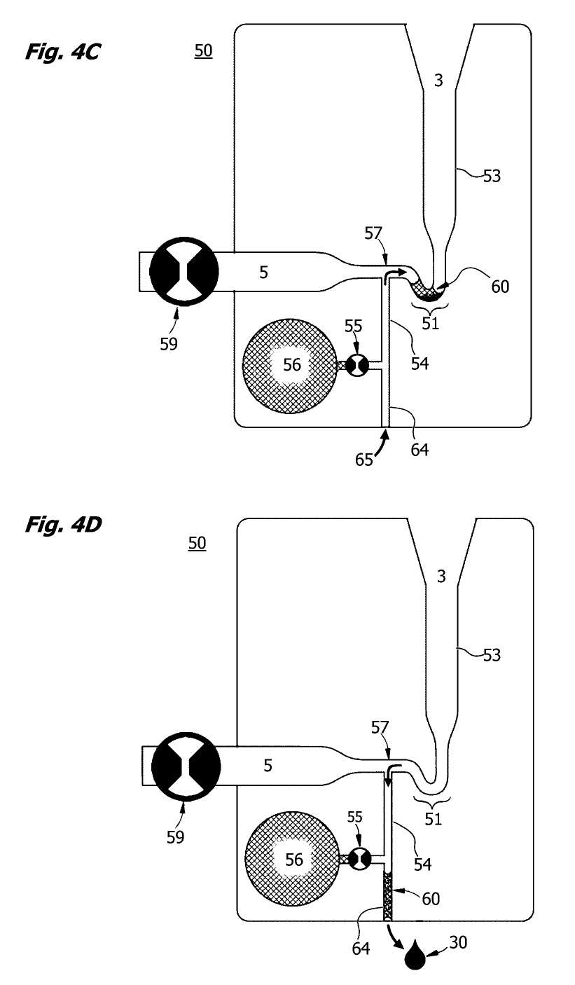

FIGS. 4A through 4D describe use of a collection module 50 with on-board reagent reservoir 56. Dispensing of the reagent occurs by action of a pressurizable diaphragm over the reagent chamber and valve 55. As shown in FIG. 4A, an aerosol stream 6 is drawn in at the top of the collector collector channel 53 via intake orifice 2, receiving arm 3 and particle trap 51, where aerosol particles are deposited according to the cut-off characteristics of the inertial impactor. Particle-depleted outlet stream 7 exits the outlet arm 5 at an orifice, which is connected to a suction pressure. Outlet arm 7 is provided with a stopcock 59, for turning on and off the vacuum connection. Aerosol particles form a particle deposit 61 on the inside of the particle trap 51 by centrifugal impaction.

To elute captured particles and collect a liquid sample from the impactor, stopcock 59 is closed (FIG. 4B), valve 55 is opened, and a microdroplet volume 60 of an elution fluid from reagent reservoir 56 is injected into the collector channel via microfluidic injection duct 54 and tee 57. Valve 55 is then closed. The microdroplet 60 is moved onto the impactor surface, thereby contactingly eluting the deposited particles 61 from the impactor (FIG. 4C). A remote micro-syringe pump (not shown) fluidly attached to sampling duct 64 is used, for example, to supply air 65 to push the droplet 60 through injection duct 54, tee 57, and onto the impactor surface. The syringe pump is then reversed, drawing the microdroplet volume 60 out of the collector channel via tee or “injection port” 57 and sampling duct 64 (FIG. 4D), where the liquid sample 30 is collected for analysis or archiving. In this way a highly concentrated aerosol suspension or solution is obtained in a microvolume of liquid sample 30. While not limited by particularities of detail, this method is generally applicable.

By extensive experimentation, we have discovered working inertial impactors that can be designed and fabricated with dimensions and features ranging from 200 to 1500 microns in the collector channel and impactor while operating at sub-sonic gas stream linear velocities. Aerosol particle deposition on the walls of the collector, depending on the nature of the particles, need not occur solely due to inertial forces acting on the particles; the deposition may be forced or aided by electrostatic forces.

FIG. 5A describes the results of calculations showing the effect of collector channel diameter on cut-off size for centrifugal inertial impactors. The cut-off size (rₚ) corresponds to a collection efficiency of 50% for that particular particle size.

For comparison, all curves are constructed at constant flow rate of 0.5 L/min at STP; shown here are plots for 0.5 L/min in tubular collector channels having, from left to right, diameters of 500, 600, 750, 1000, 1500 and 2000 microns, respectively.

The radius of curvature (R_{c}) for all the illustrated impactors of FIG. 5A is 0.66×ID, a constant; ie. a bending radius of ⅔ the characteristic dimension (channel height or diameter ID). Because the minimum theoretical bending radius is 0.5×ID, these figures represent generally optimized collector geometry for tubular and rectangular channels. Shown in FIGS. 5B and 5C are centrifugal impactor structures having a radius of curvature of 0.5×ID and 0.66×ID, respectively. The radius R_{c} is taken from the axial center of the bend to the centerline of the channel, while maintaining a constant characteristic dimension or internal diameter ID of the channel. Comparison reveals that for an impactor with R_{c} less than 0.66×ID, the “septum” 105 between the two arms of the impactor is nearing impracticably thin and as R_{c} approaches 0.5×ID (FIG. 5B), the thickness of the septum 105 approaches zero, a limit that cannot be overcome. Also labeled on the diagram are the receiving arm of the collector 102 and the centrifugal impactor or “particle trap” 101.

The dimensions of the collector and centrifugal impactor are characteristically microfluidic or near-microfluidic dimensions. The dimensions of the particle trap 101, are such that at least one cross-sectional dimension of the collector microchannel and impactor surface is generally smaller than 1500 microns and the radius of curvature as measured along the centerline of the collector channel is generally 0.5 to three or about ten times the height or diameter of the channel. Typically, the “trap” portion of the collector channel forming the centrifugal impactor surface has at least 120 degrees of bending arc, more preferable 180 degrees, although 360 degree loops are also conceived and is generally less than 1500 microns in one dimension. The trap portion may have a radius of curvature which is greater than 0.5 and is generally less than 10. The volume in the trap portion is thus generally less than 10 microliters, and volumes of liquid reagent satisfactory for “microelution” are less than 10 microliters, preferably less than 1 microliter.

Returning to FIG. 5A, the corresponding average gas velocities V_{dot} were calculated to be 42.4, 29.5, 18.9, 10.6, and 4.7 meters per second. The corresponding particle cut-offs (as aerodynamic diameter) were found to be about 0.63 micron for the 500 micron ID trap, 0.81 micron for the 600 micron ID trap, 0.96 micron for the 750 micron ID trap, 1.74 micron for the 1.0 mm ID trap, and 3.31 micron for the 1.5 mm ID trap.

The significance of these figures for capture of bioaerosols is clear. Bacteria such as E. coli have an aerodynamic diameter in the range of 0.7 to 1.0 microns, Bacillus anthracis spores are in the range of 0.8 to 1.5 microns, and viruses are in the range of perhaps 20 to 120 nm (although viruses are typically aerosolized as larger composite particulates such as bronchial secretions or weaponized particulates containing excipients). Therefore, the ability to detect particles in the sub-micron range, down to 0.7 microns, is critical. As can be seen, centrifugal particle traps having diameters in the range of 200 to 750 microns ID are shown to meet the required criterion for cut-off size at flow rates in the range of 0.5 to 1.0 L/min. It should be recalled that the collector throughput is frequently a minor flow received from an upstream concentrator array, and taking 1000:1 or 2500:1 as maximal reasonably achievable flow splits in air-to-air concentrators at present, suitable collection efficiency and throughput are obtained. Happily then, a useful sub-micron particle size cutoff and flow throughputs of 1250, 2500 L/min, or greater, are obtained with the inertial impactor collectors described in the figure.

In fact, particle traps having an ID or characteristic dimension (typically the height) of the channel of 0.2 mm were also operable in our hands, and achieve sub-micron cut-off sizes with flow rates as low as 0.07 to 0.1 L/min. Larger flow rates may be achieved by widening the channel while maintaining the radius of curvature, as in a rectangular channel having width greater than height. Thus, for practicing the invention, we conceive as useful channels having a characteristic dimension of 50 to 1500 microns and mean flow rates in the collector module of 0.05 to 10 L/min. With wider channels in the collector, and using flow splits of 2500:1 in an upstream air-to-air concentrator, sampling rates of 25 cubic meters per min of air are possible.

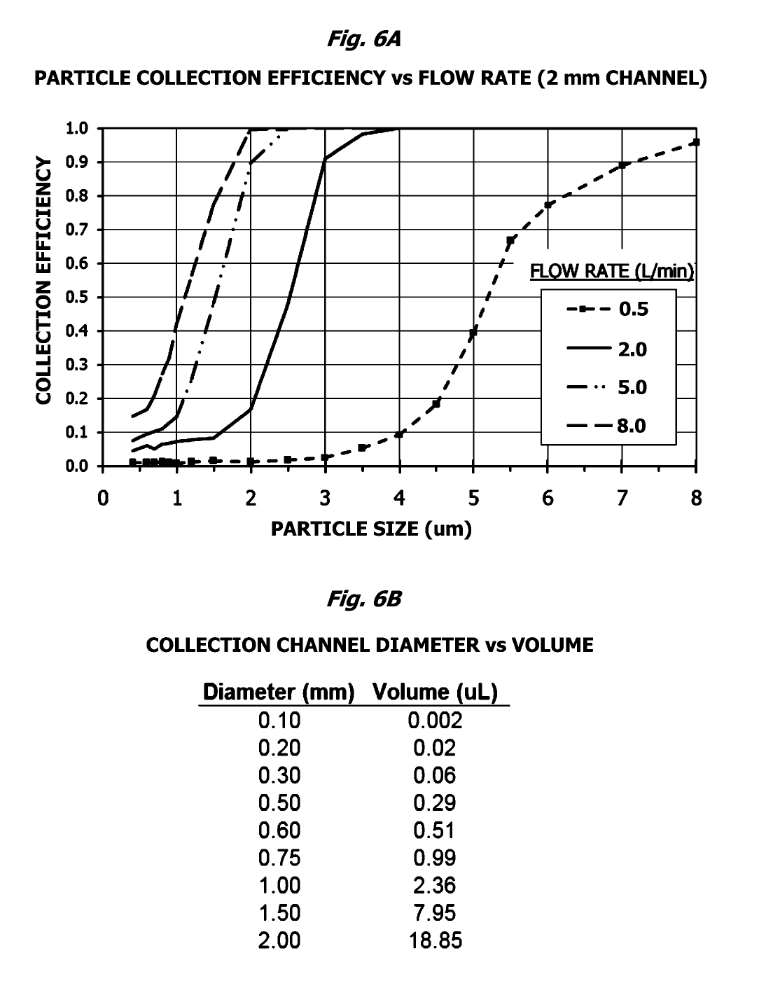

In contrast, at 2 mm ID, the performance is reduced. It can be seen from FIG. 5A that the cut-off size in a 2 mm tube at 0.5 L/min is greater than 5 microns; not satisfactory for many applications. Increased velocity V_{dot} does not correct this deficiency. Shown in FIG. 6A is the effect of increased velocity on particle collection efficiency as a function of particle size. It can be seen that as velocity of the gas stream is increased from 0.5 to 8.0 L/min, the particle size cut-off still does not reach the desired sub-micron range. Certain technical difficulties are expected in configuring a 2 mm tube for higher throughput velocities. In contrast, although mean linear velocity of a 0.5 mm impactor trap operated at 0.5 L/min and a 2 mm impactor trap operated at 8 L/min are essentially equal (about 40 m/s), the particle cut-off in the 0.5 mm device is 0.63 microns versus 1.15 microns in the 2 mm device due to the faster maximum linear velocity and laminar velocity profile. These figures assume optimal collector bend radius for each device. Interestingly, for a 300 micron collector channel, the mean linear velocity in the trap is almost 120 m/s at a V_{dot} of only 0.5 L/min, indicating that smaller, sub-millimeter collector channels are qualitatively superior over the 2 mm channel, successfully capturing the required range of particles at split fractions which more efficiently use the upstream capabilities of a compatible aerosol concentrator. Taking 3×ID as the length of the centrifugal trap, where ID is the internal volume of the channel, the volume of the trap segments are readily compared as a function of diameter (here considering only tubular channels). The data is tabulated in FIG. 6B. The volume of the particle trap for channels of 100, 200, 300, 500, 600, 750, 1000, 1500, and 2000 microns ID shifts dramatically from 20 microliters for a 2 mm particle trap to 2 nanoliters for a 100 micron particle trap, essentially a 10,000-fold decrease in volume for a 20-fold decrease in diameter. Thus the synergy of use of a particle trap having microfluidic or near microfluidic dimensions extends not only to the success in capturing sub-micron particles, but also resuspending or solubilizing those particles in a dramatically smaller volume, a microliter volume, and in some cases a nanoliter volume.

Again the technical advance is that with combinations having an inertial collector of the present invention, aerosol particles in a cubic meter of air or more can be reduced to a liquid volume of a few microliters, or even a few nanoliters! The invention is thus a very highly concentrative air-to-liquid converter, generating microdroplet liquid samples of concentrated aerosol particles. What is surprising is that the microfluidic-sized or near-microfluidic sized particle traps can be successfully operated—as demonstrated by the following data is taken from actual experimentation.

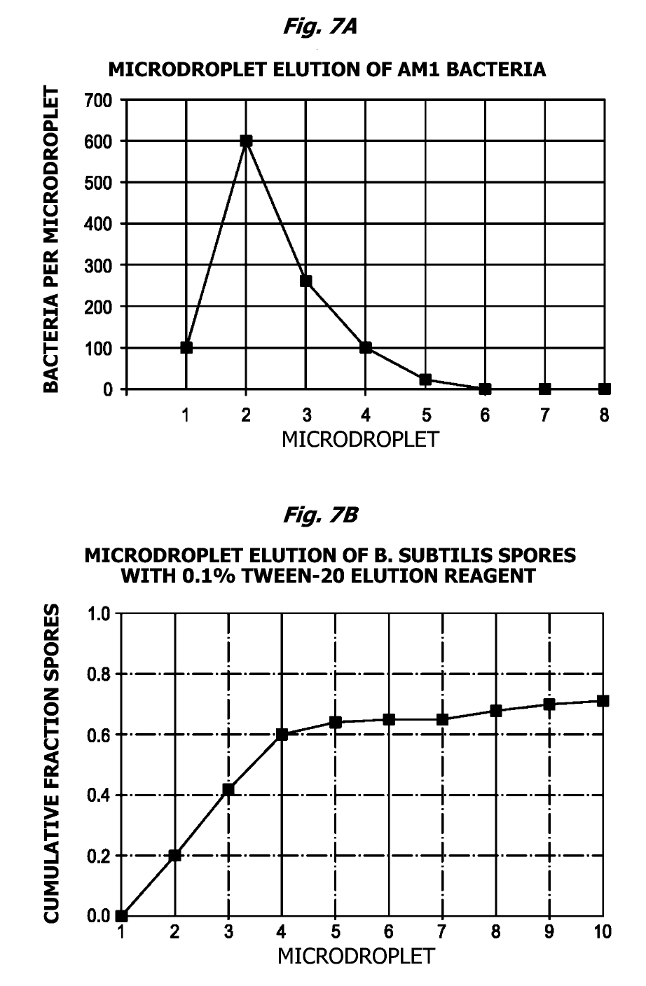

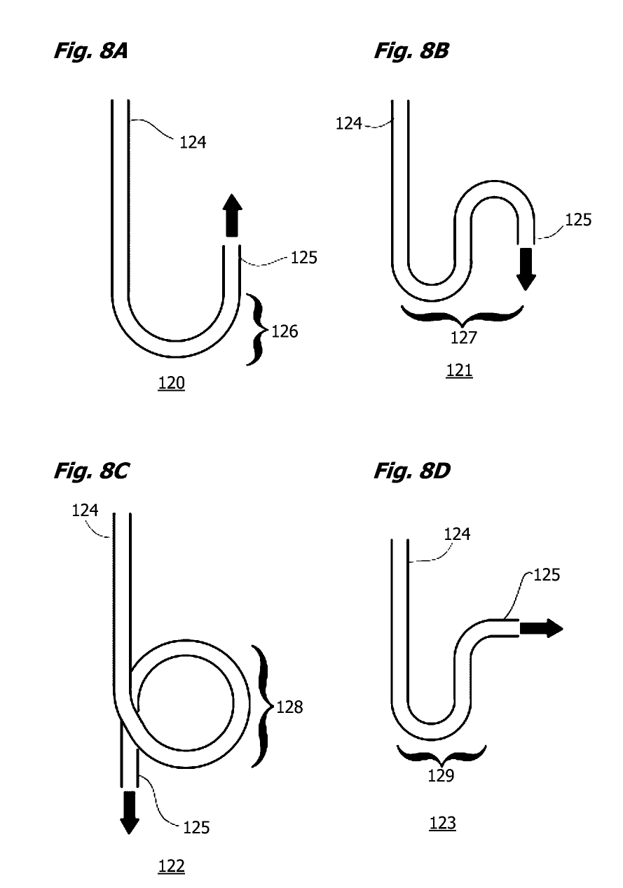

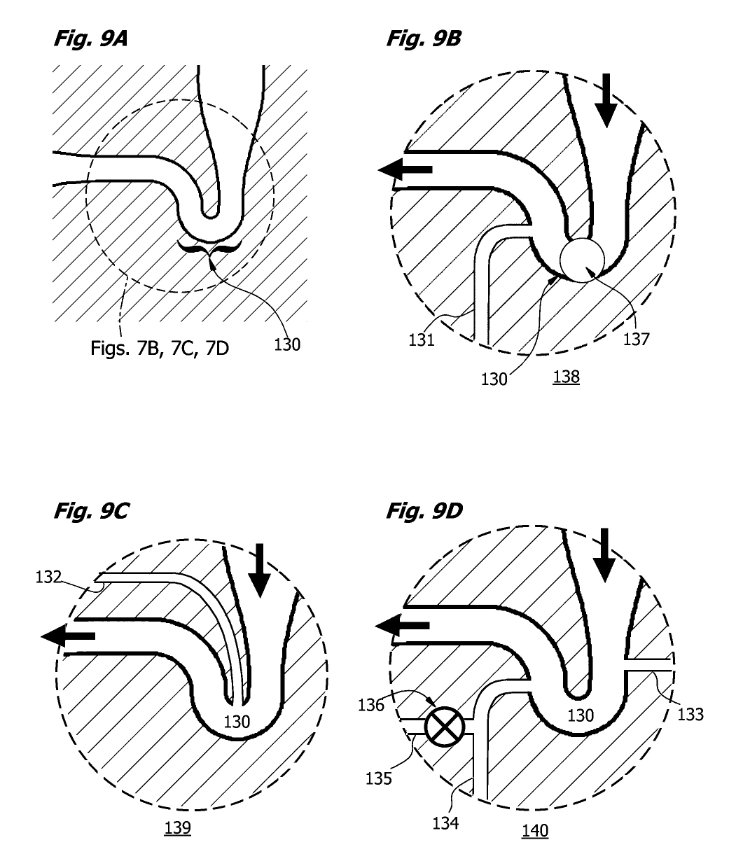

FIG. 7A shows the results of an experiment in which particles trapped in a centrifugal impactor were eluted with microvolume droplets of a fluid. The particles used in the experiment are viable bacteria of a species (Methylobacterium extorquens AM1) not characteristic of ambient air. After aerosolizing and collecting a sample, a series of microvolume droplets was used to elute the bacteria from the impactor surface. In this case, aqueous 0.1% Tween 20 was used as the elution fluid. The volume of each droplet was 500 nL. Each 500 nanoliter droplet was injected into the collector channel and collected separately for analysis by culture. Bacteria per microdroplet represent the number of viable cells recovered in each droplet. As can be seen, after an initial wet out, most of the bacterial cells appear in the second droplet passed through the collector channel. Thus most of the viable bacteria were collected in a single drop! This surprising result demonstrates feasibility of the process conceptualized generally in FIG. 4.

A similar result is shown in FIG. 7B, in which the target particles were bacterial spores (Bacillus subtilis) of a non-pathogenic cousin of the Anthrax pathogen. Again, 500nanoliter droplets of an elution reagent were injected into a micro-U-tube collector channel containing spores captured from a gas stream. Each droplet was recovered and analyzed by culture. Spores per microdroplet are plotted cumulatively. Surprisingly, it can be seen that by the fourth droplet, substantially all of the viable spores were recovered, corresponding to a total eluate volume of 2 microliters and a cumulative elution efficiency of almost 70%. Estimates of total spores in the system are based on spore counts from filter membranes blocking the outlet stream 7.

Variants of centrifugal impactor particle trap geometry (120,121,122,123) are contemplated, as shown in FIGS. 8A-D. The exact shape is chosen for efficiency and convenience, and the internal bore may be variable in diameter. Each impactor is shown with a receiving arm 124 and an outlet arm 125. Shown in brackets (126,127,128 and 129) are the trap-like concavoconvexedly curved portions of the collector channel which form the centrifugal impactor surfaces. These bent tubular channels are generally configured with bending segments having more than 120 degrees of bending, optionally up to 360 degrees of bending.

In FIG. 9A, modifications of a centrifugal “particle trap” are shown. The detail (dotted circle) highlights the centrifugal impactor surface or “trap” (130), which is formed of a concavoconvex bend in the collector channel, the concavoconvex bend of the channel having a windward wall and a leeward wall. As gas streamlines break away from the linear direction of flow and follow the leeward wall, particles with more momentum collide with the windward wall in the bend. Particles captured in the trap 130 are eluted for analysis by injecting a liquid reagent into the collector channel. As can be seen in FIGS. 9B-9D, where the detailed view area selected in FIG. 9A (dotted circle) is magnified in three embodiments of the invention (138,139,140) these embodiments also include at least one microfluidic duct (131,132,133,134,135) for injection or collection of a liquid reagent. The ducts are generally in fluidic connection with a pump functionality or member for pumping a sample or a reagent, and optionally in fluidic connection with a reservoir (not shown) for dispensing a reagent or receiving a sample. The duct can serve as a common duct for injection of one or more reagents, and the pumping means can be configured to provide reversible pumping so that the liquid sample can be withdrawn from the trap 130 after the captured aerosol material trapped therein is suspended or solubilized. Alternatively, as previously noted, a liquid reagent is used to resuspend or solubilize the aerosol, and if desired the sample is then analyzed in situ in the trap. In FIG. 9B, an embodiment 138 with optical or acoustic window 137 or light pipe is shown. The optical window or light pipe is used to examine the liquid contents of the eluted aerosol sample in place in the trap 130. Waveguides mounted centrally in a microfluidic channel in communication with the liquid sample may also be used for in situ analysis, as has been described in U.S. Pat. Nos. 6,082,1185 and 6,136,611. In FIG. 9D, an embodiment 140 with three microfluidic ducts (133,134,135) is shown. One duct serves as an injection duct, one as a sampling duct, and another for introducing at least one reagent. Alternatively, fluid or air can be introduced in two ducts, for example 133,134, so as to alternate the direction of motion of a microdroplet or droplets in the trap 130. By injecting trains of droplets separated by pulses of air from another duct, an interface between the droplets is created that facilitates mixing and plug flow. Branched duct 135 may also be used so that multiple fluids can be added stepwise, as in performing an assay, and the ducts can be valved 136 as desired.

In another aspect, a liquid dispensed by the microvolume pump means is itself the inertial impactor surface. In this configuration, a low melt glassy matrix is deposited on the surface of the inertial impactor. A glass soluble in a liquid is chosen for the matrix. Once aerosol particles are collected, the glass layer is dissolved in a liquid is then transferred to a microfluidic circuit for processing downstream in an analytical module, which may be integrated or separate from the collector body.

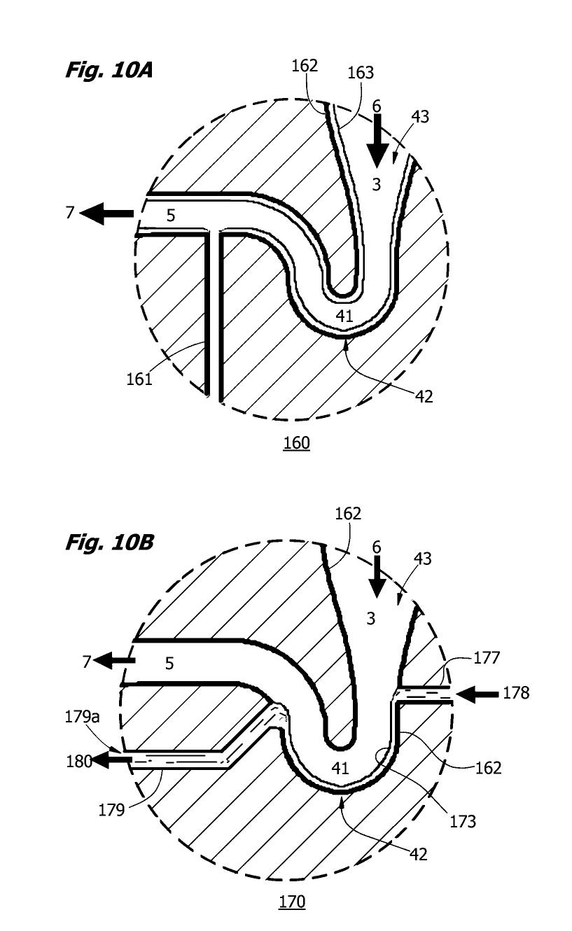

FIGS. 10A and 10B describe embodiments (160, 170) in which the impactor surface 16, of a centrifugal impactor 15, is coated with a glassy matrix material prior to collection. In FIG. 10A, the collector channel 43 has an inside undersurface 162 and the inside surface is coated with an overlayer 163, termed herein a “sacrificial substrate overlayer” because the layer is intended dissolve on exposure to an elution agent, thus aiding in the elution of aerosol material captured its surface. As before, a gas stream 6 with particle concentrate moves through the collector from receiving arm 3 to outlet arm 5 and is depleted 7 of aerosol particles in trap 15 according to the cut-off characteristics of the impactor. Elution fluid is injected through injection duct 161 and is directed onto the impactor surface 42 of the trap 41, where the sacrificial substrate overlayer 163 and any particulate material trapped on the overlayer is dissolved. The concentrated liquid sample or “eluate” thus prepared may be further reacted in situ and analyzed or may be conveyed to a sampling port for downstream or remote analysis.

In FIG. 10B, collector channel 43 has an inside undersurface 162 and within the trap 41 the inside surface 162 is coated with an overlayer 173, termed herein a “sacrificial substrate overlayer” because the layer is intended dissolve on exposure to an elution agent, thus aiding in the elution of aerosol material captured its surface. As before, a gas stream 6 moves through the collector from receiving arm 3 to outlet arm 5 and is depleted 7 of aerosol particles in trap 41 according to the cut-off characteristics of the impactor. In this illustration, the sacrificial substrate overlayer 173 is injected as a glassy melt 178 above the Tₘ for the substrate through a reagent injection duct 177 and is directed onto the impactor surface 42 of the trap 41 where it may be allowed to harden and subsequently, after particle loading, be remelted for collection via sampling duct 179. The sacrificial overlayer 173 thus can serve as an elution reagent. Or a continuous flow process is envisaged in which the liquid reagent 178 is continuously injected into the trap at injection port 177 and continuously withdrawn as a particulate concentrate 180 at sampling port 179a. By controlling the rate of flow of the liquid reagent, the concentration of particulate in the sample can be raised or lowered. The liquid sample or “eluate” thus prepared may be further reacted in situ and analyzed or may be conveyed to a sampling port for downstream or remote analysis. Various combinations of the embodiments 160 and 170 are also envisaged.

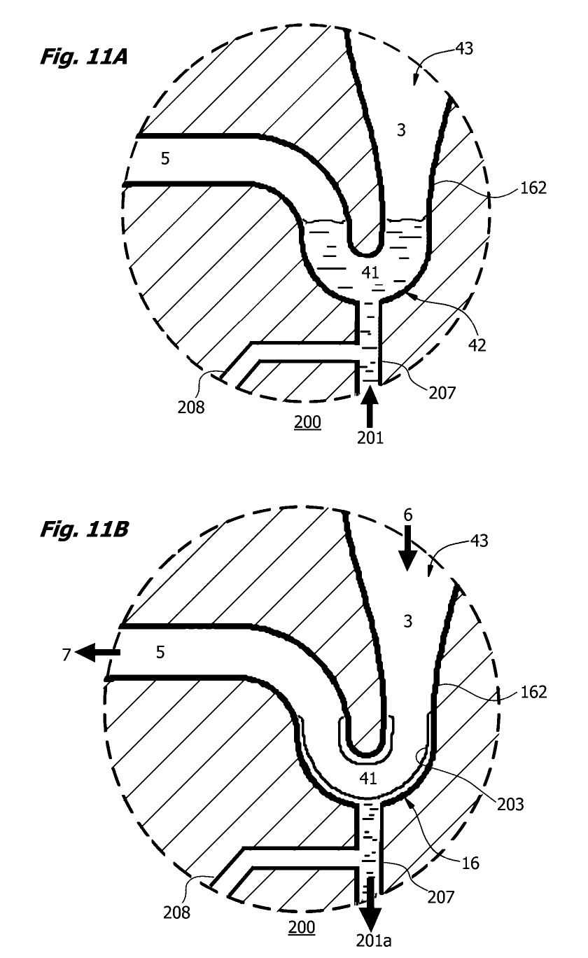

In FIGS. 11A and 11B, a process for regenerating a glassy sacrificial substrate overlayer is described. The glassy matrix 201 is an amorphous solid when solidified and a liquid when melted. Liquid glass is first injected via warmed injection duct 207 to fill the lower bending portion of the trap 41 (FIG. 11A). The lake of material then drained as shown in FIG. 11B, leaving a thin overlayer 203 lining the inside undersurface 162 of the collector channel 43.

As before, a particle concentrate in a gas stream 6 moves through the collector from receiving arm 3 to outlet arm 5 and is depleted 7 of aerosol particles in centrifugal impactor trap 41 according to the cut-off characteristics of the impactor. An elution fluid may then be injected via injection duct 208 and the sacrificial substrate overcoat 203 is dissolved or melted into the liquid sample, eluting with it essentially all of the captured aerosol material and airborne agents, if any.

Alternatively, glass layer 163,173,203 may be coated on a “primer” layer of a hydrophobic or fluorophilic substance such as a silane, parylene, or perfluorocarbon lining the collection channel so that upon dilution with an aqueous reagent, the eluate beads up as a microdroplet. In this case, binders are used that improve the adherence of the glass to the underlying primer.

In another aspect, the glass layer 163,173,203 contains dry reagents such as enzymes or chromogens for treating or analyzing the liquid sample when hydrated or dissolved. Some biological reagents such as enzymes are advantageously stabilized during storage by a glass matrix as described here.

Microelution with Soluble Glass Sacrificial Substrate Overlayer

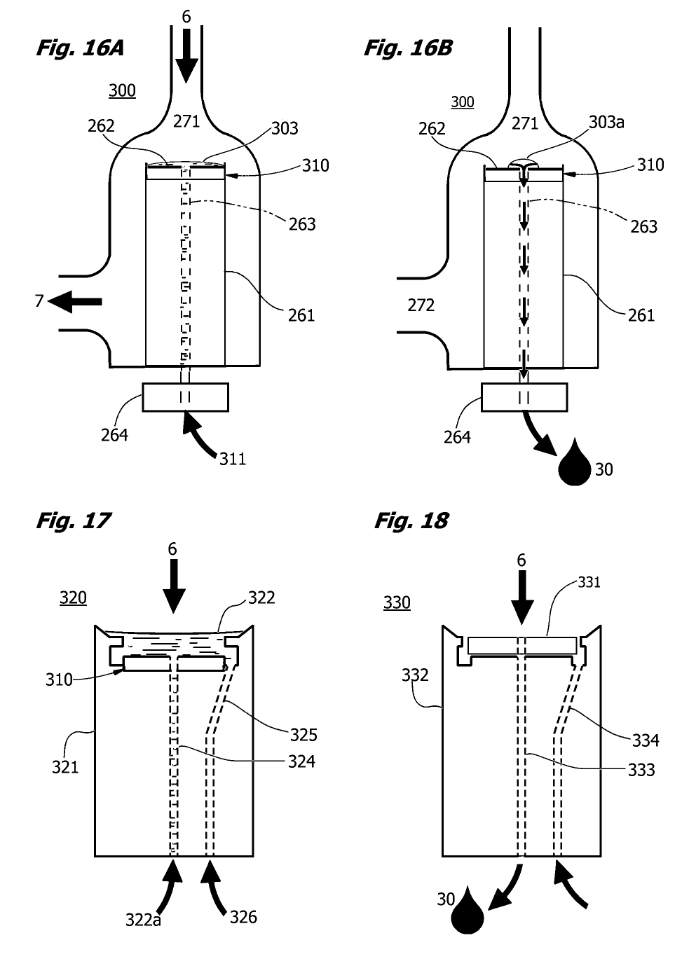

Sacrificial glass substrate overlayers on the inside of the particle trap impactor surface or surfaces is advantageous for microelution of captured particles. Basic formulations for use as glass sacrificial overlayers are now discussed and are applicable to all classes of particle traps. The sacrificial substrate layer is preferably a glass, having a T_{g} and a Tₘ in the range of 0 to 200° C., more preferably melting at 10 to 20° C. above a setpoint. Glasses, including arabinose, erythritol, fructose, galactose, glucose, lactose, maltitol, maltose, maltotriose, mannitol, mannobiose, mannose, ribose, sorbitol, sucrose, trehalose, xylitol, xylose, dextran, or a mixture thereof, formed as an amorphous glass, are suitable. Other glasses may also be suitable and the above list is not intended to be limiting. For example, lactic acid and capric acid are candidate glasses when used with a suitable eluant. In some cases, eutectic mixtures are used to lower the melting temperature as desired. Optionally, mixtures formed of one or more of the above glass-formers and a plasticizer are prepared so as to adjust the melting temperature and the viscosity as desired. Plasticizers may include but are not limited to glycerol, dimethylsulfoxide, lower molecular weight poly- ethyleneglycol, ethylene glycol, propylene glycol, diethylene glycol dimethylether, triethylene glycol dimethyl ether, tetraethylene glycol dimethyl ether, N,N-dimethylacetamide, N,N-dimethylformamide, tetramethylurea, water, or a mixture thereof. Plasticizers also serve to prevent formation of any crystalline domains if necessary. Binders are used to strengthen the glass, which must resist the forces associated with the gas stream, and to aid in adhesion of the glass sacrificial layer (163,173,203; see also FIGS. 16-18) to the collector body undersurface (162). Suitable binders include but are not limited to polyvinylpyrrolidinone, higher molecular weight poly-ethyleneglycol, a block copolymer of poly-propyleneglycol and poly-ethyleneglycol, polyacrylate, poly-methylmethacrylate, poly-(d,1-lactide-co-glycolide), triethylene glycol dimethyl ether, butyl diglyme, chitosan, a cellulose, methylcellulose, an alginate, an albumin, or a dextran. Less useful are relatively insoluble binders such as starch and gelatin. Thus the sacrificial substrate overlayer can consist of a glass or a glassy matrix comprising a mixture of a glass with a plasticizer or a binder, or a glass with a plasticizer and a binder. A suitable solvent is used to dissolve the sacrificial layer, thereby releasing any captured aerosol particles resident thereon. Heat may be used to facilitate melting of the glass.

Prior art teachings teach away from formulations of this nature. Various modifications of the inertial impactor surface, such as described in U.S. Pat. No. 4,452,068 and use of greases such as described by Marple in U.S. Pat. No. 4,321,822, and in U.S. Pat. Nos. 4,764,186, 4,827,779 and 5,693,895 have been proposed as means to reduce elastic collisions which result in retrainment of aerosol particles in the gas flow and losses from the impactor surface. U.S. Pat. No. 6,363,800 to Call forming a coating on the impactor surface with parylene (a hydrophobic polymer) or tetraglyme (a polyol) for enhancing capture of aerosols, but do not teach use of a substrate layer which is substantially eroded and dissolved in the elution fluid. Ta Won Han of Rutgers Univ has proposed using Lotusan®, a superhydrophobic paint (see U.S. Pat. No. 6,660,363), to improve aerosol elution efficiency from inertial impactors, but has not, to our knowledge, reported success with bacteria. Thus the prior art teaches hydrophobic or sticky surfaces, but does not teach erodible sacrificial surface layers to improve elution efficiency from inertial impactor surfaces. Also not disclosed are surfaces that are solubilized by melting or by a combination of melting and addition of a solubilizing reagent or diluent.

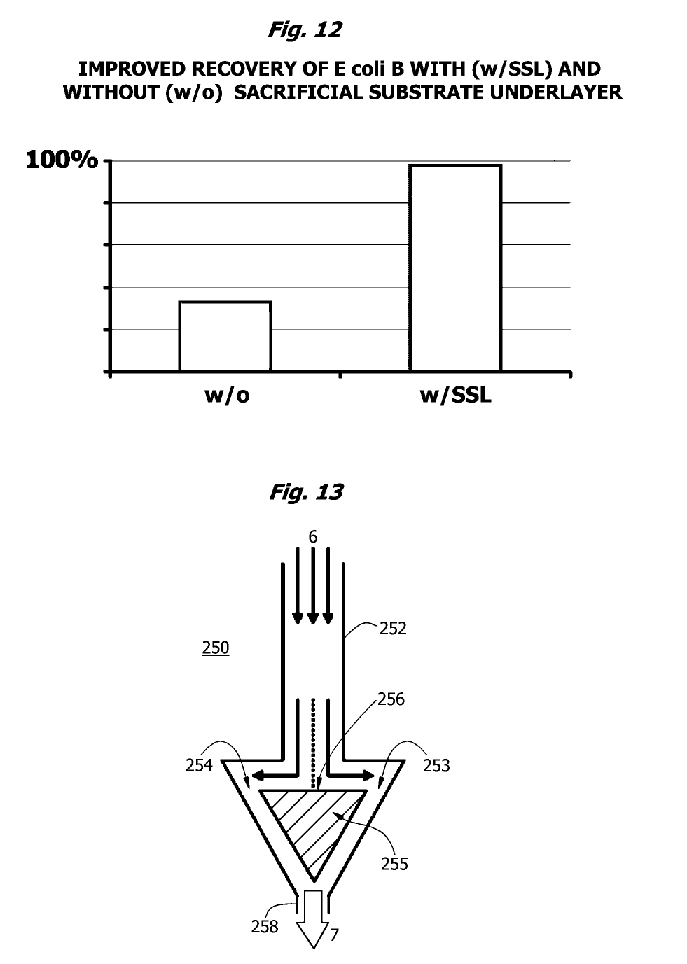

FIG. 12 shows how a sacrificial substrate overlayer improves elution efficiency of Escherichia coli B impacted on an inertial surface. Elution of E. coli is surprisingly successful using this approach in spite of the disruptive shearing impaction and its effect on gram negative bacteria. Elution efficiencies of E. coli from untreated impactor surfaces are in some instances less than 35% in aqueous solutions. Happily, upon use of a sacrificial substrate overlayer, we have discovered that elution efficiency increases to essentially 100% (column labeled “w/SSL” on plot), a surprising finding and a contribution that makes a distinct technological advance. For example, 80% trehalose with 10% glycerol and 10% polyvinylpyrrolidinone in aqueous ethanol may be applied as a thin layer within a trap in a plastic collector body. By application of this technique, elution in liquid sample microvolumes is achieved for a gram negative rod, but the technique is applicable to a variety of bioaerosols and particulate toxins, including spores and virus particles, and for example bioagents trapped in a mucous matrix, which are typically adherent to impactor surfaces and difficult to elute. Similar results are also obtained with bluff body impactors and electrostatic impactors modified with a sacrificial substrate overlayer, as will be described below.

### Bluff Body Inertial Impactors

We now turn to bluff body impactors. The design of a collector module is not limited to the bending channel geometry of a centrifugal impactor. The collector module may employ a bluff body with a windward surface facing a gas stream in a collector channel such that the gas flow streamlines are deflected but particles impact on the surface of the bluff body. A schematic of a bluff body impactor 250 is shown in FIG. 13. This class of impactors includes cascade impactors and liquid impingers. Microdroplet elution as described below is readily adapted to various members of the class.

In FIG. 13 we see the gas stream 6 in a receiving arm 252 of a collector channel is divided and flowing in lateral channels to the left and right (253,254) of a central bluff body 255. The windward surface (in this case the uppermost surface) of the bluff body is the impactor surface 256. Aerosol particles (dotted line) are impacted by inertia on the impactor surface 256. A particle depleted exhaust 7 exits the bluff body impactor 250 at an outlet arm 258 of the collector.

The dimensions of the collector and bluff body impactor are characteristically microfluidic or near-microfluidic dimensions. The dimensions of the bluff body impactor surface, also sometimes termed a “microfluidic particle trap”, are such that at least one cross-sectional dimension of the collector microchannel and impactor surface is generally smaller than 1500 microns. The collection volume of elution reagent applied to the windward impactor surface is generally less than 10 microliters and preferably less than 1 microliter, and is sometimes only a few nanoliters to a few hundred nanoliters. Microfluidic pumps and valves as previously described for centrifugal impactors may be used to form bluff body impactors interfacing with microfluidic circuits.

The bluff body impactor can be assembled within a channel fabricated (etched, milled, or molded) on a surface and sealed by another mating surface, or fabricated as a monolithic solid using 3D photolithography.

In another aspect of the invention, as shown in FIGS. 14A and 14B, a three-dimensional bluff body impactor 260 is shown. The central bluff body member 261 is a freestanding pillar or supporting column, the head of which is an inertial impactor surface 262. The column 261 is provided with an internal first microfluidic channel 263 in fluid communication with the impactor surface 262 via injection port 265 and with a pumping means 264 and fluid reservoir (not shown). A gas stream 6 entering the receiving arm 271 of the collector 260 is depleted of aerosol particles by impaction on bluff body impactor surface 262 and exits the collector at outlet arm 272 as a depleted gas stream 7. When a useful mass of aerosol particles are collected on the impactor surface 262, the first microfluidic channel is used to dispense a liquid reagent 266 onto the impactor surface. As shown in FIG. 14B, any eluted particulate material is then collected by withdrawing the fluid back through the first microfluidic duct 263. Liquid sample 30 is collected at a sampling port, although it should be understood that the invention is not limited to this option and that in situ analytical techniques are also contemplated. Aerosol particle suspensions or solutions obtained in this way can be highly concentrated in a very small volume of a liquid reagent.

Pump functionality 264 is for example a small syringe pump and is capable of switching direction of flow. A bidirectional pump means is useful both for wetting the impactor to elute captured aerosol particles and for withdrawing the liquid sample containing the aerosol particle suspension or solution for further analysis. Other pump utilities as described earlier may also be used.

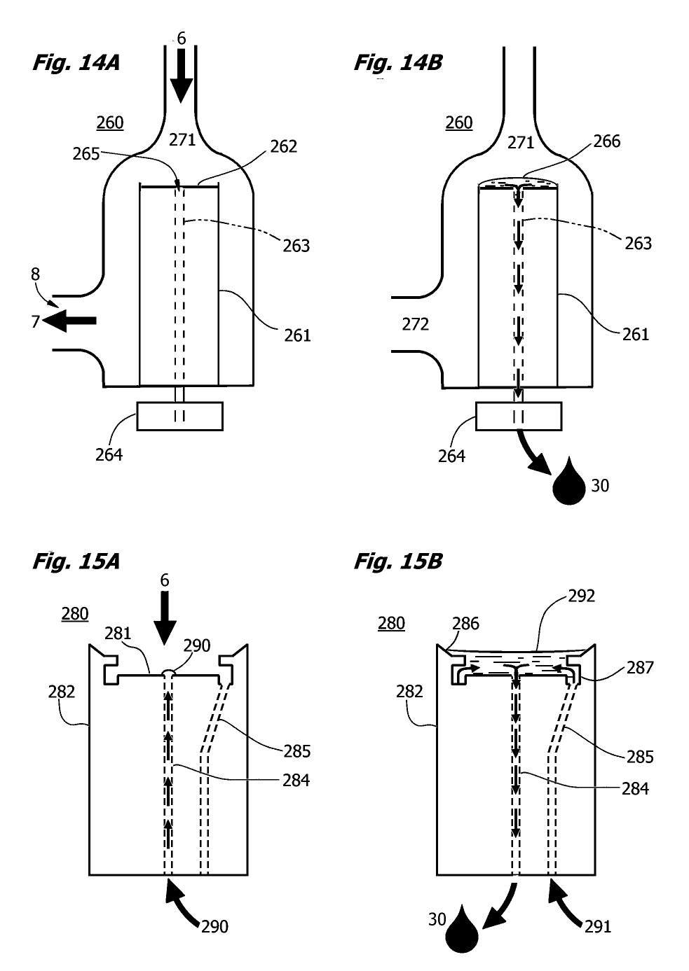

In FIGS. 15A and 15B, a related bluff body impactor 280 having two microfluidic channels in a cylindrical support pillar or column 282 is shown. As before, aerosol particles are captured by impaction from a gas stream 6; impacted aerosol particles collect on impactor surface 281, and elution fluid 290 is injected onto the impactor surface via injection duct 284. The liquid sample is pre-processed (FIG. 15B) by adding analytical pre-processing reagent 291 via microfluidic duct 285, the reaction mixture 292 filling moat 287 and held in place by dike 286. The liquid sample is optionally withdrawn through microfluidic sampling duct 284 if desired. In a related embodiment, the second channel 285 is used to periodically add a detection reagent 291 such as a chromogen, antibody, or a substrate of an enzyme which reacts with a particular species of aerosol particle if present on the impactor. Using this apparatus, an ELISA assay may be run in situ on entrapped particles, for example. Liquid samples 30 positive by ELISA are then drawn off for further analysis.

According to another aspect of the invention, as shown in FIGS. 16A and 16B, a three-dimensional bluff body impactor 300 is shown. The center bluff body 261 is a freestanding pillar or supporting column, the head of which 262 is coated with a sacrificial substrate overlayer 303 (the thickness is exaggerated for clarity), the surface of the glass layer 303 forming the inertial impactor surface. The bluff body impactor support column 261 is provided with an internal microfluidic channel 263 in fluid communication with the impactor surface 262 and with a pumping means 264 and fluid reservoir (not shown). A gas stream 6 entering the receiving arm 271 of the collector 300 is depleted of aerosol particles by impaction on bluff body impactor glass surface 303 and exits the collector at outlet arm 272 as a depleted gas stream 7. When a useful mass of aerosol particles are collected on the glass layer 303, resistive heating element 310 mounted in the head is used to melt the glass. Hot liquid reagent 311 is then pumped onto the impactor surface where it dissolves the glass layer 303. As shown in FIG. 16B, the melted glass 303a containing eluted aerosol particles is then withdrawn via microfluidic duct 263 and reversible pump 264, and is collected as liquid sample 30. The liquid sample can be conveyed to an external analytical station or can be analyzed in place.

In a variant of this embodiment, a glassy matrix layer on the impactor surface forms a sacrificial substrate overlayer 303 on the windward surface of the impactor 262, so that particles colliding with the impactor directly contact and adhere to the glass layer. The sacrificial substrate overlayer 303 is injected as a liquid melt onto the impactor surface through microfluidic duct 304 and hardened in place. A resistive heating element 310 is used to melt the glass, which has a low Tₘ. As shown in FIG. 16B, the liquid sample 30 (ie. the melted glass 303a) is then withdrawn from the impactor surface through microfluidic duct 263 for downstream analysis. Thus the glass is both impactor surface and elution reagent.

In another aspect, the glass 303 contains dry reagents such as enzymes or chromogens for treating or analyzing the liquid sample when hydrated or dissolved.

More complex variants are envisaged, as shown in FIG. 17. Impactor resistive heating element 310 may be combined with bluff body impactor support member 321. An impactor surface formed of a sacrificial glass layer 322 is cast in place by injection of the low melt glass as a liquid 322a through warmed microfluidic duct 324 onto the windward surface of the impactor body 320 and allowed to harden in place. After collection of a suitable mass of aerosol particles from impinging gas stream 6, the solid glass 322 is melted by applying a current to resistive heating element 310 (circuit not shown) and is withdrawn through microfluidic duct 324. Liquid reagent 326 injected through a second microfluidic duct 325 is used to facilitate rinsing of the glass from the injector surface. A glass coated impactor surface of this sort can be regenerated for a subsequent cycle. Thus this embodiment 320 may be used in a regenerative cycle.

According to another embodiment of the invention, the glassy matrix 322 is held above its melting point during particle impaction, providing a viscous, sticky, but readily soluble material for capturing particles in an inertial impactor. The molten glassy matrix 322 is stable to a high velocity gas stream and resists evaporation, unlike aqueous reagents conventionally used in liquid impingers.

As shown in FIG. 18, the impactor cap element 331 forming the impactor surface on top of bluff body pillar member 332 may a) contain a piezoelectric crystal for ultrasonic treatment of the collected sample; may b) contain microelectrodes for electrowetting and electropumping of microdroplets on the impactor surface; may c) contain MEMS components such as an inkjet printer head for injecting a liquid reagent; may d) contain a flat plate capacitor or an electrode, such as would be used in an electroprecipitator, for example. As before, any aerosol particles are first collected by inertial impaction from gas stream 6. Following collection, reagents may be injected via microfluidic ducts 333 and 334 and a liquid sample 30 eluted. Chemical, physical or biological treatments may be applied directly to the liquid sample. The liquid sample may be withdrawn from the impactor cap surface 331 if desired, or an analysis may performed on the surface in situ. Thus, bluff body impactor assembly 330 is an active component with capabilities for aerosol pre-processing, sample microfluidics, and for instrumental in situ analysis in an integrated package.

Referring again to FIG. 18, in another embodiment, the cap element 331 of the pillar member 332 may be modified using microassembly or MEMS techniques. In one case, the cap surface is a specially fabricated electrode coated on its upper aspect with a silane layer and used to reversibly adhere a liquid droplet to the impactor by electrowetting. When voltage is removed, the liquid/surface interaction becomes hydrophobic and the contact angle becomes negative, facilitating withdrawal of the full microvolume. The microdroplet can be moved from side to side and across the surface of the silane layer using pairs of electrodes as described by Pamula in U.S. Pat. No. 6,911,132. As employed in the present invention, this technology is used to harvest aerosol particles from the surface of the impactor. Wiring and circuit elements are not shown, but are readily accommodated within a silicon chip supported on the pillar 332 with associated leads extending down the pillar to a power supply.

The invention should not be construed as limited only to the depicted configurations, and includes various combinations of the elements configured for particle elution in a microvolume from any centrifugal or bluff body impactor. Bluff body impactors as know in the art are not limited to pillar elements with top-mounted impactor plates, but may also be side mounted impactors adapted from those described in U.S. Pat. Nos. 4,321,822, 6,110,247, and others as would be known to those skilled in the art.

### Electrostatic Impactors

Electrostatic interactions are particularly effective in entraining sub-micron particles, which may be captured in a particle trap formed, for example, by mounting a pair of charged plates so that a gas stream flowing between the plates is exposed to an imposed electrostatic field, one plate having a positive charge and the other a negative charge. The plates are “electrostatic impactor surfaces” forming an “electrostatic particle trap” or “electrostatic impactor” and are used to trap charged aerosol particles. Particles may be natively charged or may acquire induced charge by contact with a source of ions, such sources including but not limited to a “corona wire,” a source of ionizing radiation, and a radio-frequency discharge. Ionization may be achieved, for example, by a plasma discharge from a corona array disposed in the path of the gas stream.

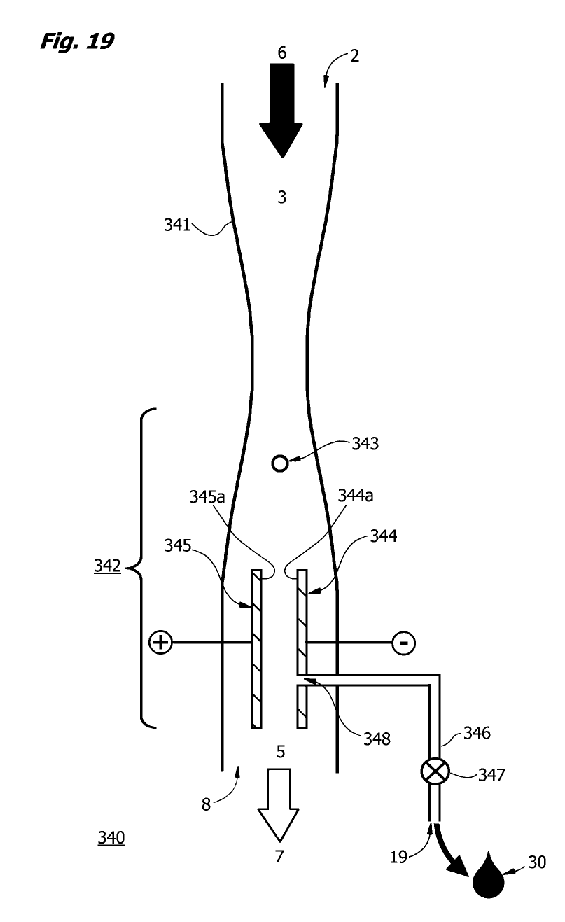

A schematic of an electrostatic impactor collector module 340 is shown in FIG. 19. Collector channel 341 is configured for receiving a gas stream 6 in receiving arm 3 via intake orifice 2. The gas stream and entrained particles are ionized by contact with corona wire 343. A pair of charged plates 344,345 trap oppositely charged particles. Particle depleted gas stream 7 exits the collector module via outlet arm 3 and outlet orifice 8. Corona wire 343 and the inside surfaces 344a,345a of the pair of charged separation plates make up electrostatic particle trap 342. Microfluidic injection duct 346 with injection port 348 and optional valve 347 is used to inject a microdroplet volume of an elution fluid and to withdraw a liquid sample 30 at sampling port 19.

The dimensions of the collector channel and electrostatic impactor are characteristically microfluidic or near-microfluidic dimensions. The dimensions of the electrostatic particle trap, are such that at least one cross-sectional dimension of the collector channel and impactor surface is generally smaller than 1500 microns. The collection volume of elution reagent applied to the electrostatic impactor plate surfaces is preferably less than 10 microliters and preferably less than 1 microliter, and is sometimes only a few nanoliters to a few hundred nanoliters. Microfluidic pumps and valves as previously described for centrifugal and bluff body impactors may be used to form electrostatic impactors interfacing with microfluidic circuits.

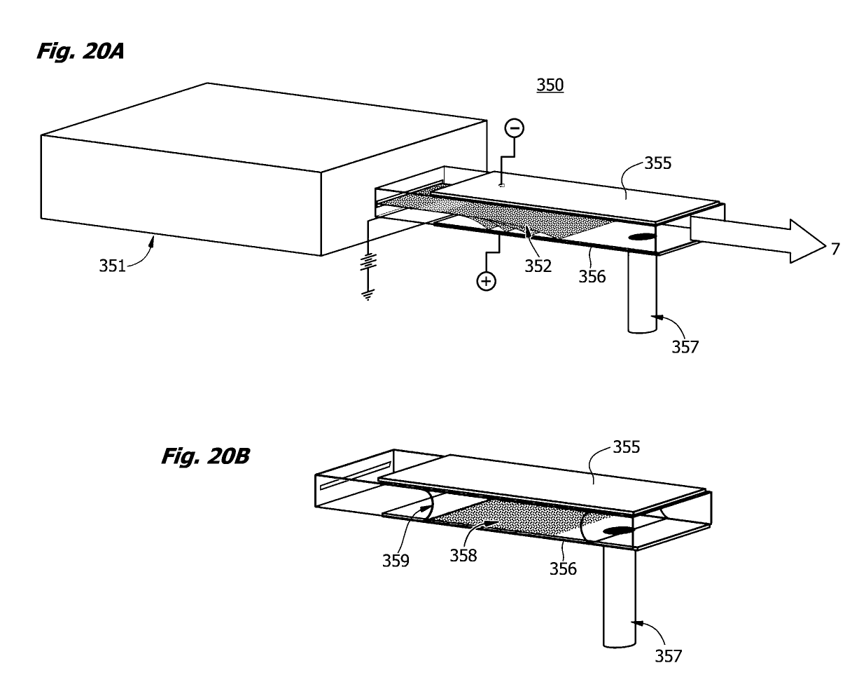

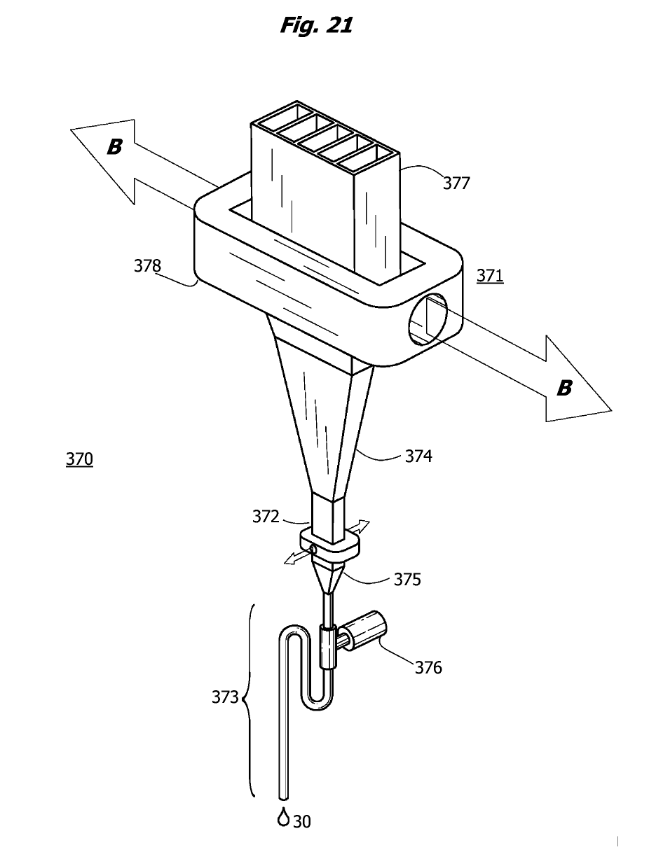

FIGS. 20A and 20B depict a second electrostatic impactor. A gas stream is received and ionized in front collector body member 351 and passed between charged plates 355 and 356. Charged particles 352 (dots) are captured electrostatically by oppositely charged plate 356, marked here as positively charged (+). Depleted gas stream 7 exits the module to the right. In FIG. 20B, a detail of the elution process is shown. Captured particles (dots) blanket the upper surface 358 of plate 356. A fluid volume 359 (shown with convex menisci) fills the space between plates 356 and 355. Microfluidic injection duct 357 is used to inject the fluid and to collect eluted particles in a liquid sample at a sampling port. A sacrificial glass overlayer may be used on the charge separation plates as a thin dielectric layer to improve elution efficiency as previously described for inertial impactors.

### Integrated Devices

The technical advantage achieved by reducing a dimension of the collector channel and particle trap to microfluidic or near-microfluidic dimensions on the order of 1500 microns or less is that a very small volume of fluid reagent can be used to collect and process the aerosol particles, or constituents thereof, captured on the impactor surface—generally a discrete microvolume of 10000 nanoliters or less, more preferably a microvolume of less than 1000 nanoliters—resulting in a very high concentration factor and improved analytical sensitivity. While it would initially appear that collector channels of this diminutive size would be undesirable because of limitations on the throughput flow rate that can be achieved at sub-sonic gas stream velocities, surprisingly, by coupling the impactors of the present invention with upstream aerosol concentrators or arrays such as those of co-assigned US Patent Application 2008/0022853, overall processing throughputs of 10, 20 or even 25000 L/min are readily achieved at sub-sonic gas jet velocities in the coupled concentrator/collector apparatus because only the particle-enriched minor flow from the aerodynamic concentrator is routed through the collector. This combination happily was found to quickly reduce the aerosol mass found in a cubic meter of air or more to a nanoliter volume of liquid sample 30 in less than a minute. The collectors of the present invention thus serve as aerosol-to-liquid conversion modules with microfluidic or near-microfluidic dimensions.

By resuspended captured particles in nanoliter-sized droplets, potentially up to a 3×10⁹-fold concentration factor over particle density in the ambient air sample may be achieved. Actual results to date in prototypes have achieved a 5×10⁶-fold concentration of microbial cells trapped on the particle trap impactor surfaces of the present invention and eluted in a liquid droplet volume of 500 nanoliters.

To achieve this synergy, the collectors of the present invention may be used in combination with aerosol concentrators such as a virtual impactor, aerodynamic lens (ADL), skimmer, venturi, nozzle, or other type of concentrator. Typically, ADLs are used in combination with skimmers and the collector would be sealedly fitted to the minor flow outlet of the skimmer. For a description of the art, the reader is referred to co-pending US Patent Application 2008/0022853, U.S. patent application Ser. No. 12/125,458, and to the works of Marple and others (cf. Chen, B T and H C Yeh (1985) A Novel Virtual Impactor: Calibration and Use, J Aerosol Sci 16: 343-354; in Novick V S and J L Alvarez (1987) Design of a multi-stage virtual impactor, Aerosol Sci Tech 6:63-70; in Loo B W and C P Cork (1988) Development of high efficiency virtual impactors, Aeros Sci Techn 9:167-176; in Marple V A et al (1980) Virtual Impactors: a theoretical study, Environ Sci Tech 14:976; and in Goo, J (2002) Numerical simulation of aerosol concentration at atmospheric pressure by a cascade of aerodynamic slit lenses, J Aerosol Sci 33:1493-1507) and to a representative selection of virtual impactor designs found in U.S. Pat. Nos. 3,901,798, 4,301,002, 4,670,135, 4,767,524, 5,425,802, 5,533,406, 5,788,741, 6,062,392, 6,386,015, and 6,402,817.

As shown in FIG. 21, an aerosol concentrator module 371 in combination with an aerosol collector module 373 of the present invention is depicted. Combination 370 of a two-stage ADL array, with first skimmer, first stage adaptor 374, second ADL and skimmer 372, second stage adaptor 375, and centrifugal aerosol collector 373 is illustrated. Also shown is a pump functionality or member (376) with tee for injecting a liquid reagent and for eluting particles deposited in the particle trap 373, here shown as a bent capillary tube which forms the collector body. Liquid sample 30 is collected at the base of the apparatus. Two-stage

ADL aerosol concentrator modules having a flow split of 2500:1 (bulk flow divided by minor flow) or more are compatible with the inventive collector modules.

While outside the scope of this discussion, the upper 5× ADL array (377) in FIG. 21 is used in combination with the first stage skimmer with exhaust manifold 378 to separate a particle-enriched core flow (termed the ‘minor flow’) from a bulk flow (marked “B”) that is depleted in particles. The particle-concentrated gas stream is then conveyed to the collector 373 through first stage adaptor 374, and optionally as shown here, passed through a second stage ADL/skimmer 372, resulting in a second bulk flow split and further concentration of the particle content of the gas stream, which is routed into the collector via adaptor 375.

The purpose of this combination 370 is to provide a virtual impactor/inertial impactor combination which is capable of a) sampling ambient aerosols at high sampling flow rates and concentrating those aerosols as a concentrated particle beam; b) impacting the particles from the particle beam in a collector and capturing them; and c) solubilizing or suspending the particle deposit in a microdroplet volume for analysis. The upstream concentrator module delivers a concentrated aerosol stream (“minor flow”) that is injected into the collector channel. In this way, total system throughput can be increased to 20, 30 or even 25000 L/min while retaining the ability to sample impacted aerosol material in microdroplet volumes. This is a distinct technological advantage, increasing detector sensitivity and assay speed. Happily, this combination 370 was found to quickly reduce the aerosol mass found in a cubic meters of air or more to a few nanoliters of liquid sample 30 in less than a minute.

As shown, the collected particles can be eluted from the capillary wall with a very small droplet or a series of droplets of elution fluid, even nanoliter-sized droplets, enabling large concentration factors and affording significant technical and cost advantages relative to current devices. In the case of biological particles, analysis of the collected particles may be performed using a variety of detection methods such as immunological or nucleic acid assays or culturing. The ability of this device to collect large numbers of particles in a short time and deliver them into small fluid volumes offers the possibility to significantly enhance the speed and sensitivity of existing detection and identification methods.

Thus in one aspect the invention is a combination of an ADL and skimmer module (or other air-to-air concentrator) and an “aerosol collector module”, for example as exemplified by collector with microelution features 10a, 10b, 40, 50, 250, 260,280, 300, 320, 330, 340, 370, 450a, 450b, 450c and the variant collector devices and apparatus described herein. Collector modules comprise a receiving arm 3, 102, 124, 252, 271 for receiving a gas stream 6, an outlet arm 5, 125, 258, 272 for discharging a particle depleted exhaust 7, and a particle trap 4, 41, 51, 101, 126, 127, 128, 129, 130, 250, 256, 262, 281, 303, 322, 331, 342, 350, 358 with microfluidic injection/sampling duct 11, 26, 28, 44, 54, 64, 131, 132, 133, 134, 135, 161, 177, 179, 207, 208, 263, 284, 285, 324, 325, 333, 334, 346, 357, 444a, 444b, 444c for injecting a reagent and eluting a liquid sample 30 in a microdroplet volume. These “collector modules”, as termed herein, are optionally combined in a single integrated body or assembled on an apparatus scaffold so that disposable elements can be speedily replaced.

In addition to the collector module, a complete aerosol sampling apparatus may include an upstream aerosol concentrator module, plumbing and flow control components, and remotely mounted microfluidic components for eluting the particles from the collector. The detection and analysis of the eluted sample may be performed downstream of the collector body by a number of methods which require delivery of aerosol or its chemical constituents in liquid suspension e.g.: surface plasmon resonance, high performance liquid chromatography/mass spectrometry (HPLC/MS), ICP/MS (Perkin-Elmer), MALDI/MS, FABS, GC/MS, PCR, ELISA, etc, or may be performed in situ in the collector body, for example via an optical window through the particle trap or a waveguide mounted in a microfluidic sampling duct.

The collector module can be a disposable component of the system, whereas the pumps, flow meters, flow controllers, other hardware for in-situ sample analysis will be multi-use components. However, if the detection technique requires the use of small channel cavities formed in expensive materials (e.g. etched channels in quartz) such a collection device can be reusable. Regenerated impactor surfaces 203,322 are envisaged.

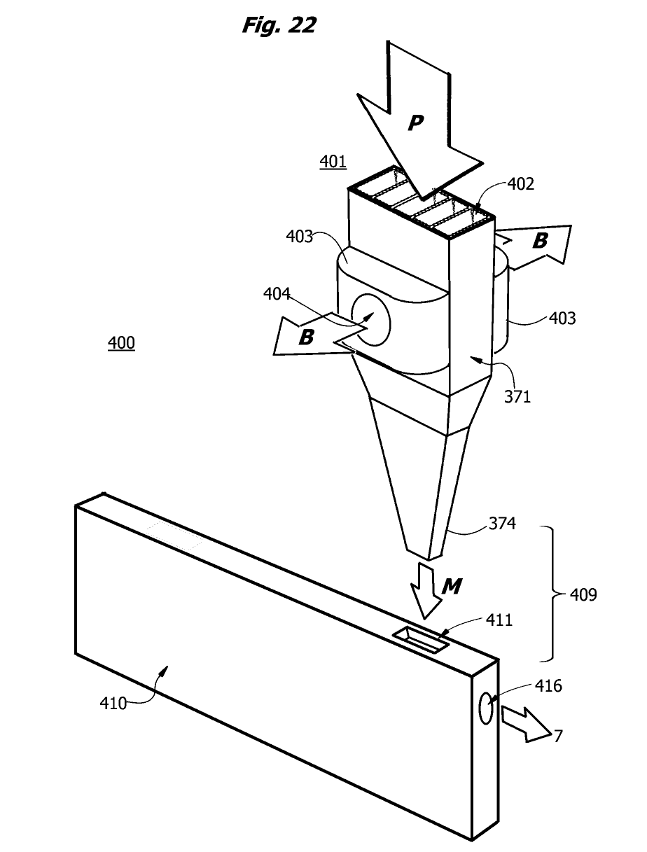

FIG. 22 is an illustration of a combination 400 of a single-stage aerosol concentrator aerosol and a collector module integrated inside a microfluidic card 410, the microfluidic card having partially integrated on-board detection and identification capability. An aerosol-laden gas stream (P) enters an aerosol concentrator module 401 at inlet 402. A bulk flow (B) is separated from a minor flow (M) in an aerodynamic lens array 371. The bulk flow is diverted to waste through manifolds 403 and outlet port 404. The particle-enriched minor flow from the ADL array enters a funnel-like adaptor 374, the adaptor having means for sealedly joining 409 the adaptor to microfluidic cartridge 410. Receptacle 411 is part of the joining means 409 and serves to convey the minor flow (M) from the aerosol concentrator module 401 to the collector, which is integrated in microfluidic cartridge 410. The collector is a centrifugal impactor, bluff body impactor, or electrostatic impactor integrated inside the microfluidic cartridge 410 and is not shown here, but representative collectors in various embodiments are shown in FIGS. 1, 2, 3, 4, 5B, 5C, 8, 9, 10, 11, 13, 14, 15, 16, 17, 18, 19, 20, 21, 22 and 23. Inside the microfluidic cartridge 410, particles are captured in a particle trap as previously described. A vacuum is used to pull the minor flow through the collector. Depleted particle exhaust 7 exits the cartridge at outlet port 416. This concentrator/collector/detector combination 400 illustrates a modular aerosol concentrator with fluidic connection to an integrated micro-collector and microfluidic analysis cartridge.

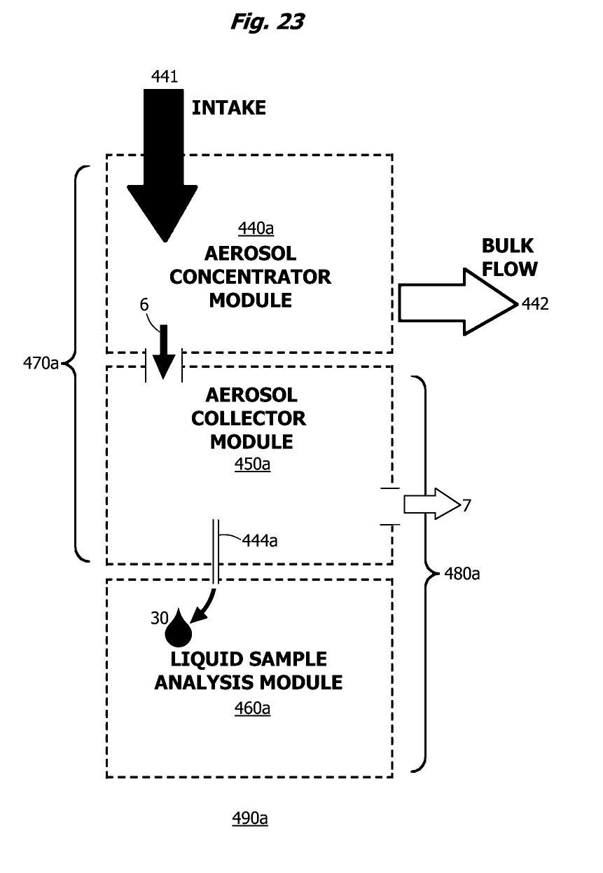

Turning now to FIG. 23, a schematic is presented showing how modular elements of a concentration-collection-analysis apparatus may be interfaced as a fully functional aerosol concentrator/liquid sample collector/and analytical apparatus 490a. Modules 440a, 450a, and 460a are fluidly connected and are configured to function as an aerosol-to-liquid converter. Module 440a, an aerosol concentrator module, is capable of processing 20, 30, 1000 or more liters per minute of a gas at intake 441 and diverting a major fraction of that gas, depleted of particles, to bulk flow exhaust 442. The “particle-enriched gas stream” 6 is then routed into module 450a, an aerosol collector module with particle trap and micro-elution capability via microfluidic duct 444a which is adapted for interfacing with analysis module 460a. Particle trap components (not shown) of module 450 include inertial impactors and electrostatic impactors. While not limiting, microfluidic duct 444a is part of a fluid handling system for eluting particles collected in the particle trap and conveying solubilized or suspended liquid sample 30 for downstream analysis in module 460a, a “liquid sample analysis module”. Liquid sample analysis module 460a is an integrated microfluidic analytical workstation for performing one or several analytical subroutines, such as liquid chromatography, lateral flow chromatography, ELISA, nucleic acid amplification and detection, PCR, fluorescence spectroscopy, and other means for detecting as are desired.

Integration in construction may be advantageously accomplished by joining modules 440a and 450a in an integrated solid body 470a consisting of an aerosol concentrator and an aerosol collector. Integration of modules 450a and 460a into a single solid body 480a may also be advantageous if desired. All three modules, 440a, 450a and 460a may also be joined in a single integrated device 490a. Conversely, it may be advantageous to supply each of the three modules separately, so that, for example, the aerosol collector module 450a and the liquid sample analysis module 460a are disposable.

According to another embodiment of the invention, the aerosol concentrator module 440a and liquid sample module 460a are framed in an apparatus with supporting pumps, fans, vacuum pumps, waste sinks, reagent reservoirs, electrical supplies, temperature controls, spectrophotometers, analytical instrumentation, and so forth, and the aerosol collector module 450a is a disposable part that is fluidly plugged in for each analytical run.

According to another embodiment of the invention, the aerosol collector module 450a is fluidly plugged into an apparatus containing the aerosol concentrator module 440a for an analytical run, and following the run, the aerosol collector module 440a, which is for this embodiment a small block of plastic with embedded collector channel and particle trap, is then removed and forwarded to a separate workstation for sample preparation and analysis.

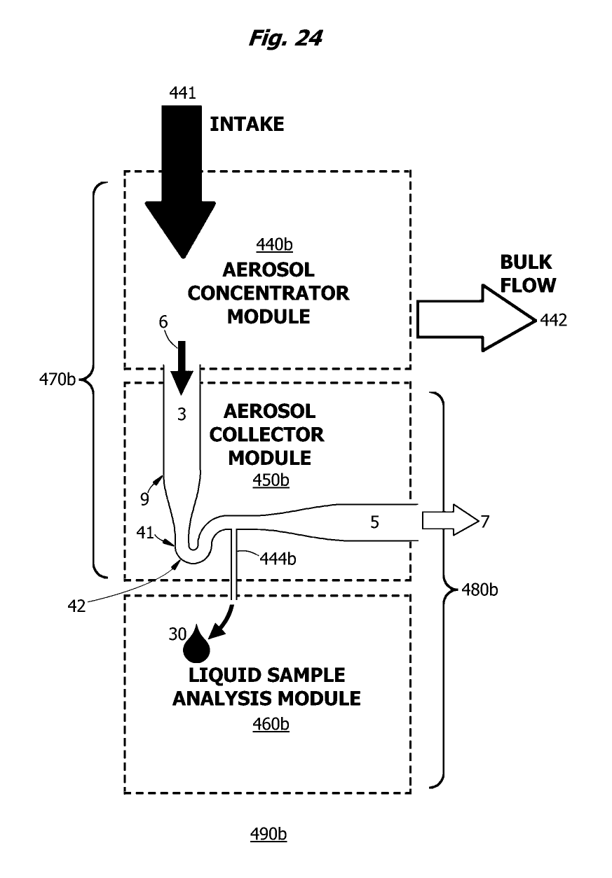

In FIG. 24 a modular aerosol-to-liquid converter 490b with centrifugal impactor 41 is shown. Modules 440b, 450b, and 460b are fluidly connected and are configured to function as an aerosol-to-liquid converter. Module 440b, an aerosol concentrator module, is capable of processing 20, 30, 1000 or more liters per minute of a gas at intake 441 and diverting a major fraction of that gas, depleted of particles, to bulk flow exhaust 442. The particle-enriched gas stream 6 is then routed into module 450b, an aerosol collector module with collector channel 9, receiving arm 3, centrifugal impactor 41, impactor surface 42, outlet arm 5, and micro-elution capability via a microfluidic duct 444b which is adapted for delivering liquid sample 30 to liquid sample analysis module 460b. Liquid sample analysis module 460b is configured with means for detecting as desired.

Integration in construction may be advantageously accomplished by joining modules 440b and 450b in an integrated solid body 470b consisting of an aerosol concentrator and an aerosol collector. Integration of modules 450b and 460b into a single solid body 480b may also be advantageous if desired. All three modules, 440b, 450b and 460b may also be joined in a single integrated device 490b. Conversely, it may be advantageous to supply each of the three modules separately, so that, for example, the aerosol collector module 450b and the liquid sample analysis module 460b are disposable.

According to another embodiment of the invention, aerosol collector module 440b is a small block of plastic with embedded collector channel and particle trap, which is removed so that the liquid sample 30 may be forwarded to a separate workstation for sample preparation and analysis.

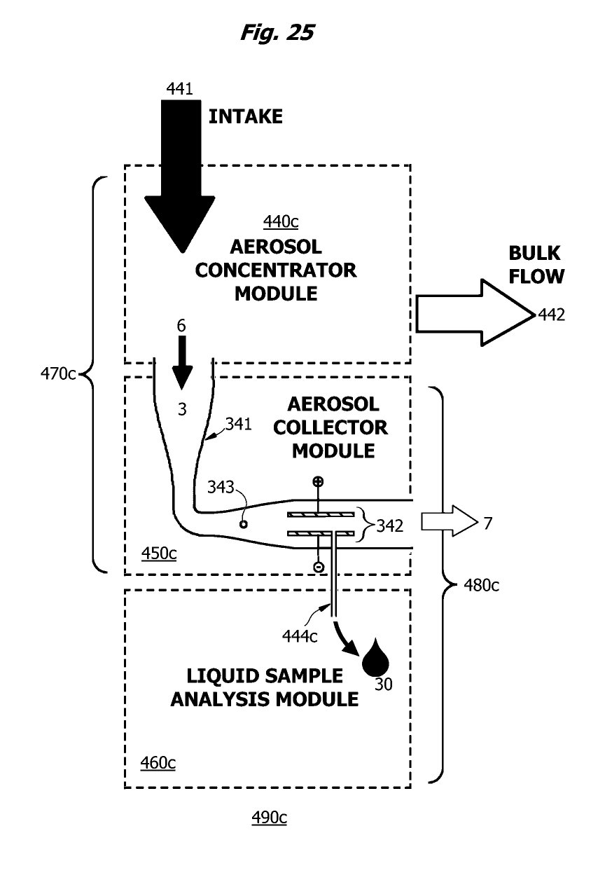

In FIG. 25 a modular aerosol-to-liquid converter 490c is shown. Modules 440c, 450c, and 460c are fluidly connected and are configured to function as an aerosol-to-liquid converter. Module 440c, an aerosol concentrator module, is capable of processing 20, 30, 1000 or more liters per minute of a gas at intake 441 and diverting a major fraction of that gas, depleted of particles, to bulk flow exhaust 442. The particle-enriched gas stream 6 is then routed into module 450c, an aerosol collector module with collector channel 341, receiving arm 3, corona wire 343, electrostatic particle collector 342, and micro-elution capability via a microfluidic duct 444c, which is adapted for delivering liquid sample 30 to liquid sample analysis module 460c. Liquid sample analysis module 460c is configured with means for detecting as desired.

Integration in construction may be advantageously accomplished by joining modules 440c and 450c in an integrated solid body 470c consisting of an aerosol concentrator and an aerosol collector. Integration of modules 450c and 460c into a single solid body 480c may also be advantageous if desired. All three modules, 440c, 450c and 460c may also be joined in a single integrated device 490c. Conversely, it may be advantageous to supply each of the three modules separately, so that, for example, the aerosol collector module 450c and the liquid sample analysis module 460c are disposable.

According to another embodiment of the invention, the aerosol concentrator module 440c and liquid sample module 460c are framed in an apparatus with supporting pumps, fans, vacuum pumps, waste sinks, reagent reservoirs, electrical supplies, temperature controls, spectrophotometers, analytical instrumentation, and so forth, and the aerosol collector module 450c is a disposable part that is inserted so as to be fluidly and electrically connected for each analytical run.

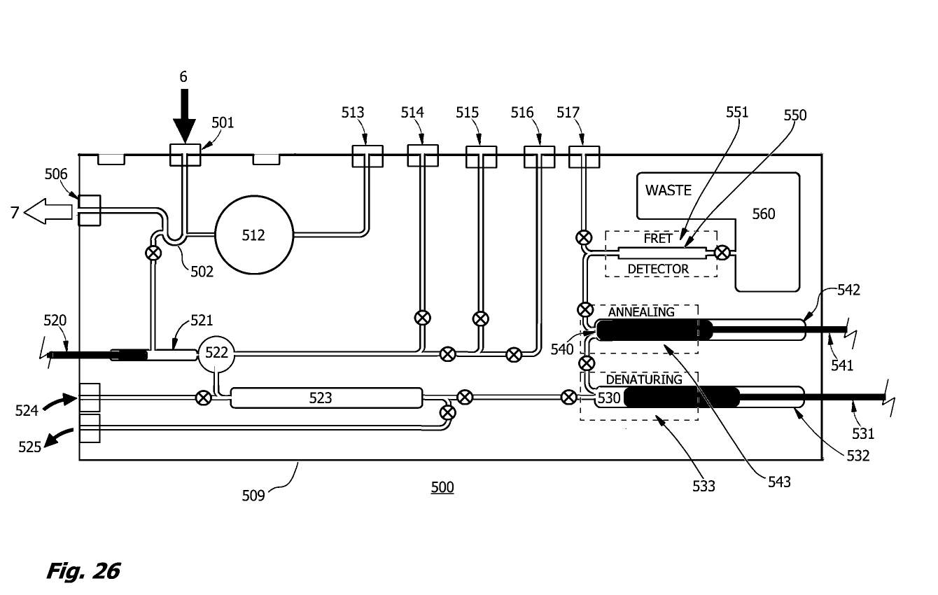

Analysis by PCR is an embodiment of a means for detecting an aerosol particle or aerosol constituent comprising a nucleic acid. In FIG. 26, the workings of an illustrative microfluidic cartridge 500 with integrated particle trap for analyzing a liquid sample by molecular biological techniques are shown in more detail. Gas stream 6 enters the cartridge through receptacle 501 and any aerosol particles and nucleic acid constituents are trapped in a particle trap 502 (although the workings of a centrifugal impactor are shown, the principle of operation is not limited to centrifugal impactors) before the depleted gas stream 7 is drawn to waste by a downstream vacuum source coupled to the cartridge at outlet 506. The analytical process is performed within the plastic body 509 of microfluidic cartridge 500.

When the vacuum is shut off, inkjet printer head 512 injects elution fluid 513 from an off-card reservoir into particle trap 502, eluting the aerosol sample material. Plunger 520, a micro-syringe pump 521, draws the liquid eluate from the impactor trap and reversing the plunger stroke forces the liquid sample into an in-line chamber 522 which is fitted externally with an ultrasonic PZT transducer (not shown) and a diaphragm made of polyethylene terephthalate, or some suitable material. The action of the ultrasonic transducer is brief, but results in disruption of cellular structures and spores in the sample, releasing nucleic acids. A lysis solution 514 is added to augment the disruptive force of the ultrasound in chamber 522. The material is then transferred to a solid state extraction chamber 523 which functions as an affinity column for nucleic acid, as first described by Boom (U.S. Pat. No. 5,234,809). Following rinse with ethanol 515 to remove cellular lipids, sugars and other detritis, and a brief exposure to air 524 to vent the ethanol to an external trap 525, a low-ionic strength PCR buffer 516 is used to elute nucleic acids adsorbed to the solid state extractant in column 523. By opening valves and actuating plunger 531 of micro-syringe pump 532, the eluted nucleic acids are moved into a denaturation chamber 530 and heated to a denaturation temperature by first heating element 533. While not shown, an intermediate temperature could be used in combination with reverse transcriptase so that ssRNA could also be analyzed by this method. The denaturation chamber 530, or microfluidic channels joining the chamber, also contain dried reagents, including the heat-stable polymerase, primers and essential cofactors and NTP nucleotides required for PCR. The denatured material is then moved to the annealing chamber 540 by action of a second plunger 541 and syringe pump 542. Temperature in the annealing chamber is controlled by a second heating element 543. In the annealing chamber, primers hybridize and chain elongation continues until the products are returned to the denaturation chamber 530 by reciprocal action of the plungers. This heating, annealing and elongation cycle is repeated multiple times. An entire PCR reaction may be performed with a few microliters total volume in a microfluidic device on a sample of aerosol particles eluted from an impactor integrated in a microfluidic card 500. Upon completion of a required number of PCR amplification cycles, 15 to 50 cycles perhaps, the products are transferred to a FRET detector chamber 550 with variable heating element 551 and dried fluorescent molecular probes and observed using an external light source and detector (not shown) for a characteristic fluorescence melt signature of the sought-after target as a function of temperature in the FRET chamber. Upon completion of the assay, the material is contacted with a waste chamber 560 containing a disinfectant, and the entire microfluidic cartridge body 509 may be uncoupled from the reagent lines and any upstream aerosol concentrator and discarded.

In an alternate embodiment, a skimmer is also integrated into the disposable plastic body 509 of the microfluidic cartridge 500.

According to another aspect of the invention, therefore, we conceive integrated systems for analyzing an ambient air sample for an aerosol particle. The integrated systems are illustrated conceptually in the embodiments of FIGS. 21 through 25. Collector modules include centrifugal impactors, bluff body impactors, and electrostatic impactors.

In one aspect, the present invention is practiced by integrating an aerosol collector module as defined herein into a body of a microfluidic cartridge with microfluidic sub-circuitry designed to enable nucleic acid amplification and detection. Aerosol particles collected on an impactor surface are conveyed in a liquid sample into a microfluidic circuit for analysis. Disclosed are illustrative details of microfluidic circuitry for integrated nucleic acid analysis, such as by PCR.

Teachings which may be relied upon for construction of a PCR sub-circuit of the device of FIG. 26 include, for example, Nakano H et al. 1994. High speed polymerase chain reaction in constant flow. Biosci Biotechnol Biochem 58:349-52; Wilding, P et al. 1994. PCR in a silicon microstructure. Clin Chem 40(9):1815-18; Woolley A T et al. 1996. Functional integration of PCR amplification and capillary electrophoresis in a microfabricated DNA analysis device. Anal Chem 68:4081-86; Burke DT et al. 1997. Microfabrication technologies for integrated nucleic acid analysis. Genome Res 7:189-197; Kopp et al. 1998. Chemical amplification: continuous-flow PCR on a chip. Science 280:1046-48; Burns, MA. 1998. An Integrated Nanoliter DNA Analysis Device. Science 282:484-87; Belgrader P et al. 1999. PCR Detection of bacteria in seven minutes. Science 284:449-50; Lagally ET et al. 2001. Fully integrated PCR-capillary electrophoresis microsystem for DNA analysis. Lab Chip 1:102-07; Tudos A J et al. 2001. Trends in miniaturized total analysis systems for point-of-care testing in clinical chemistry. Lab Chip 1:83-95; Belgrader P et al. 2002. A battery-powered notebook thermocycler for rapid multiplex real-time PCR analysis. Anal Chem 73:286-89; Hupert L M et al. 2003. Polymer-Based Microfluidic Devices for Biomedical Applications. In, (H Becker and P Woias, eds) Microfluidics, BioMEMS, and Medical Microsystems, Proc SPIE Vol 4982:52-64; Chartier I et al. 2003. Fabrication of an hybrid plastic-silicon microfluidic device for high-throughput genotyping. In, (H Becker and P Woias, eds) Microfluidics, BioMEMS, and Medical Microsystems, Proc SPIE Vol 4982:208-219; Anderson R C et al. 2000. A miniature integrated device for automated multistep genetic assays. Nucl Acids Res 28(12):[e60,i-vi]; Yang, J et al. 2002. High sensitivity PCR assay in plastic micro reactors. Lab Chip 2:179-87; Giordano B C et al. 2001. Polymerase chain reaction in polymeric microchips: DNA amplification in less than 240 sec. Anal Biochem 291:124-132; Khandurina J et al. 2000. Integrated system for rapid PCR-based DNA analysis in microfluidic devices. Anal Chem 72:2995-3000; Chiou, J et al. 2001. A Closed-Cycle Capillary Polymerase Chain Reaction Machine. Anal Chem 73:2018-21; Yuen, P K et al. 2001. Microchip module for blood sample preparation and nucleic acid amplification reactions. Genome Res 11:405-412; Zhou X, et al. 2004. Determination of SARS-coronavirus by a microfluidic chip system. Electrophoresis. 25(17):3032-9; Liu Y et al. 2002. DNA amplification and hybridization assays in integrated plastic monolithic devices. Anal Chem 74(13):3063-70; Zou, Q et al. 2002. Micro-assembled multi-chamber thermal cycler for low-cost reaction chip thermal multiplexing. Sensors Actuators A 102:224-121; Zhang C et al. 2006. PCR Microfluidic devices for DNA amplification. Biotech Adv 24:243-84, and Zhang, C and Xing D. 2007. Miniaturized PCR chips for nucleic acid amplification and analysis: latest advances and future trends. Nucl Acids Res 35(13):4223-37. Other amplification protocols include LAMP (loop-mediated isothermal amplification of DNA) reverse transcription polymerase chain reaction (RT-PCR), ligase chain reaction (“LCR”), transcription-based amplification systems (TAS), including nucleic acid sequence based amplification (NASBA), “Rolling Circle”, “RACE” and “one-sided PCR”. These various non-PCR and variant amplification protocols have various advantages in diagnostic assays, but PCR remains the workhorse in the molecular biology laboratory and in clinical diagnostics. Embodiments disclosed here for microfluidic PCR should be considered representative and exemplary, but not limiting, of a general class of microfluidic sub-circuits capable of executing one or various amplification and detection protocols.

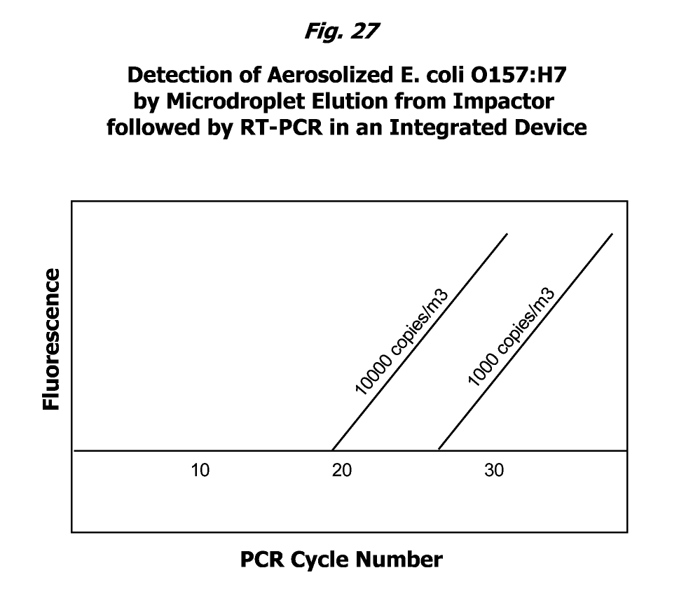

FIG. 27 shows representative data from a PCR assay performed with an apparatus of FIG. 26 as modified for RT-PCR and outfitted with an upstream aerosol concentrator module (440a,440b,440c). Such a device as modified and outfitted is representative of a fully integrated apparatus for aerosol sampling and analysis (400,490a,490b,490c). As can be seen, real-time PCR is sensitive to the “copy number” of nucleic acids in the captured bioaerosol, thus for every copy of a nucleic acid sequence trapped in an inertial impactor and amplified, there is a proportionate improvement in time to detectable signal; 10000/m³ copies gives a detectable signal by RT-PCR several cycles sooner than 1000 copies/m³. Analyses of this time are possible only if the large aerosol volume can be reduced to a small liquid sample. By use of an air-to-liquid converter combinations (470a,470b,470c) as described here, the bioaerosol content of one cubic meter or one hundred cubic meters of air for example can be analyzed as a microdroplet sample of a few microliters or less.

### EXAMPLE

A collection device of FIG. 1 was constructed of molded plastic halves and the seams sealed by ultrasonic welding. The collection channel with receiving arm and outlet arm contained a particle trap (centrifugal impactor) having an characteristic dimension of 700 microns (ID) and a radius of curvature of about 500 microns. Aerosol particles were captured by applying a suction pressure to the outlet orifice of the outlet arm. The volume of the particle trap is about 0.6 microliters, but microelution was successfully achieved with microdroplets of 500 nanoliters in volume. The aerodynamic diameter of particles captured in this device with 50% efficiency, ie., the “cut-off”, was found to be about 0.8 microns. Collection efficiency was found to be 100% for all particles 1 micron or larger in diameter. Particles successfully captured included polystyrene spheres, Bacillus spores and E. coli vegetative cells.

### Incorporation by Reference

All of the U.S. patents, U.S. patent application publications, U.S. patent applications, foreign patents, foreign patent applications and non-patent publications referred to in this specification and/or listed in the Information Data Sheet, are incorporated herein by reference, in their entirety. Aspects of the embodiments can be modified, if necessary to employ concepts of the various patents, applications and publications to provide yet further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the specifics of the disclosure.

While the invention has been described with preferred embodiments and illustrations, it is to be understood that variations and modifications may be resorted to as will be apparent to those skilled in the art. Such variations and modifications are to be considered within the purview and the scope of the claims appended hereto.

We claim,

1. An apparatus for collecting aerosol particles from a gas stream, which comprises an aerosol collector module having:
a) a collector body enclosing a collector channel, the collector channel having a receiving arm with inlet orifice for receiving an aerosol particle in a gas stream, and an outlet arm with outlet orifice for discharging a particle-depleted gas stream, the outlet orifice with connection for joining the outlet arm to a downstream suction pressure for drawing the flow of the gas stream through the collector channel;
b) a particle trap with surface or surfaces for capturing said aerosol particle disposed in the collector channel between the receiving arm and the outlet arm;
further characterized in that:
the collector channel is configured with microfluidic internal dimensions for receiving thereinto a discrete microdroplet volume of a first reagent, wherein said microdroplet volume of said first reagent, when contacted with said surfaces or surfaces of said particle trap, is an efficacious volume for eluting said captured aerosol particle as a suspension or a solution, thereby forming a discrete liquid sample for analysis.

2. The apparatus of claim 1, further characterized by:
a) a microfluidic injection duct in fluidic communication with said collection channel via an injection port in or in proximity to said particle trap;
b) wherein said microfluidic injection duct is fluidly connected to a pump functionality for injecting said discrete microdroplet volume of said first reagent contactingly onto said surface or surfaces of said particle trap; and
c) optionally a means for mixing, adding a second liquid reagent, or collecting said liquid sample at a sampling port.

3. The apparatus of claim 2, wherein said pump functionality is a microfluidic diaphragm pump, an inkjet printing pump generally, a piezo-electric pump, a syringe pump, a positive displacement pump, a magnetostrictive diaphragm pump, an electrostatic pump, a thermopropulsive pump, or a Gibbs-Marangoni pump, and the pump functionality is in fluidic connection with the microfluidic injection duct and optionally with a reservoir for dispensing said first reagent.

4. The apparatus of claim 3, wherein said pump functionality is integrated into the collector body.

5. The apparatus of claim 1, wherein said particle trap is configured with an optical window, lightpipe, lens flat, or waveguide for in situ analysis of said discrete liquid sample.

6. The apparatus of claim 1, wherein the collector channel with particle trap is configured as a centrifugal impactor, a bluff body impactor, or an electrostatic impactor.

7. The apparatus of claim 6, wherein the collector channel is configured for deflecting the gas stream across or around a surface or surfaces of said particle trap so that the aerosol particle in the gas stream is inertially impacted and captured thereon, thereby forming a centrifugal impactor or a bluff body impactor.

8. The apparatus of claim 6, wherein the collector channel is configured with an ion source for ionizing said aerosol particle in said gas stream and for electrostatically impacting said ionized aerosol particle on a first plate of a pair of opposing electroconductive plates configured for flowing said gas stream therebetween, wherein said pair of opposing plates are supplied with electrical contacts for applying a voltage thereacross, thereby forming an electrostatic impactor.

9. The apparatus of claim 1, wherein said surface or surfaces of said particle trap comprise an undersurface and a sacrificial substrate overlayer applied to the undersurface, the sacrificial substrate overlayer having solubility in the first reagent, whereby the sacrificial substrate overlayer and any captured aerosol particle thereon is eluted by dissolution of the sacrificial substrate overlayer.

10. The apparatus of claim 9, wherein the sacrificial substrate overlayer is a soluble glass or a glassy matrix comprising a mixture having in proportions a glass, a plasticizer and a binder, and further wherein the glass or glassy matrix is in a solid phase or a molten phase.

11. The apparatus of claim 9, wherein the sacrificial substrate overlayer is arabinose, erythritol, fructose, galactose, glucose, lactose, maltitol, maltose, maltotriose, mannitol, mannobiose, mannose, ribose, sorbitol, sucrose, trehalose, xylitol, xylose, dextran, or a mixture thereof; and takes the form of a solid glass or a molten glass.

12. The apparatus of claim 10, wherein the plasticizer is glycerol, dimethylsulfoxide, lower molecular weight poly-ethyleneglycol, ethylene glycol, propylene glycol, diethylene glycol dimethylether, triethylene glycol dimethyl ether, tetraethylene glycol dimethyl ether, N,N-dimethylacetamide, N,N-dimethylformamide, tetramethylurea, water, or a mixture thereof.

13. The apparatus of claim 10, wherein the binder is polyvinylpyrrolidinone, higher molecular weight poly-ethyleneglycol, a block copolymer of poly-propyleneglycol and poly-ethyleneglycol, polyacrylate, poly-methylmethacrylate, poly(d,1-lactide-co-glycolide), triethylene glycol dimethyl ether, butyl diglyme, chitosan, a cellulose, methylcellulose, an alginate, an albumin, a polypeptide, or a dextran.

14. The apparatus of claim 1, further comprising a dry reagent stored in said collector channel; having the purpose of later being rehydrated by contact with said first reagent so as to react with said aerosol particle or a constituent thereof.

15. The apparatus of claim 2, wherein said means for mixing, adding a second reagent, or collecting said liquid sample comprises a pump functionality with fluidic connection to said particle trap.

16. The apparatus of claim 1, further comprising an aerosol concentrator module configured with a flow split for forming a particle-enriched gas stream and having a fluidic outlet connection for conveying said particle-enriched gas stream to the inlet orifice of the aerosol collector module.

17. The apparatus of claim 2, further comprising a microfluidic nucleic acid analysis circuit fluidly connected to said sampling port, wherein said microfluidic nucleic acid analysis circuit is configured for analyzing said liquid sample for a nucleic acid constituent, having means for amplifying said nucleic acid constituent and means for detecting an amplicon.

18. The apparatus of claim 17, wherein said microfluidic nucleic acid analysis circuit is integrated into said collector body.

19. A process for eluting a captured aerosol particle in an apparatus of claim 3, which comprises:
a) directing an aerosol particle in a gas stream into the collector channel,
(b) impacting the aerosol particle on the surface or surfaces of the particle trap within the collector channel and capturing the aerosol particle thereon,
further characterized by:
c) injecting a discrete microdroplet volume of a first reagent onto said surface or surface of said particle trap via said pump functionality and fluidly connected microfluidic injection duct;
d) eluting the captured aerosol particle or constituents thereof from the surface or surfaces of the particle trap as a suspension or solution in said microdroplet volume, thereby forming a discrete liquid sample for analysis;
e) optionally performing an in-situ treatment of the liquid sample;
f) optionally performing an in situ analysis of the liquid sample; and
g) optionally conveying the liquid sample from the particle trap to a sampling port.

20. The process for eluting a captured aerosol particle as defined in claim 19, wherein:
said eluting step comprises pumpingly injecting a discrete microdroplet volume of the first reagent via said microfluidic injection duct onto the surface or surfaces of the particle trap using a microfluidic diaphragm pump, an inkjet printing pump generally, a piezoelectric pump, a syringe pump, a positive displacement pump, a magnetostrictive diaphragm pump, an electrostatic pump, a thermopropulsive pump, or a Gibbs-Marangoni pump.

21. The process for eluting a captured aerosol particle as defined in claim 19, wherein performing an in-situ treatment of the liquid sample comprises injecting a first reagent wherein said first reagent is a lysing reagent for lysing a bioaerosol and for releasing any nucleic acid constituents into the liquid sample.

22. The process for eluting a captured aerosol particle as defined in claim 19, wherein said step for performing optional in situ treatment of said liquid sample is selected from the following steps:
a chemical treatment comprising contacting said captured aerosol with a reagent having the purpose of chemically modifying a constituent of said captured aerosol;
a thermal treatment having the purpose of eluting or lysing said captured aerosol in said particle trap;
an ultrasonic treatment having the purpose of eluting or lysing said captured aerosol in said particle trap;
a radiological treatment with microwave or other radiation having the purpose of lysing said captured aerosol in said particle trap;
a mechanical treatment with mechanical mixing or moving of said liquid sample with said captured aerosol within the collector channel.

23. The process for eluting a captured aerosol particle as defined in claim 19, wherein said step for performing in situ analysis of the liquid sample is selected from the following steps:
inducing fluorescence of specific constituents of the liquid sample, detecting emitted fluorescent radiation, having the purpose of identifying those constituents of interest based on the spectrum of the emitted light;
measuring optical absorption of the liquid sample at one or more wavelengths; having the purpose of identifying those constituents of interest based on the spectrum of the absorbed light;
measuring light scattered from the liquid sample at one or more angles of scattering; having the purpose of quantitating or identifying those constituents of interest based on the pattern of the scattered light;
subjecting the liquid sample to a nucleic acid amplification and detecting an amplicon; having the purpose of identifying those constituents of interest based on the presence of a nucleic acid sequence;
subjecting the liquid sample to an immunological assay; having the purpose of identifying those constituents of interest based on an antigen:antibody reaction; and
subjecting the liquid sample to at least one spectroscopic measurement technique selected from Raman spectroscopy (RS), surface-enhanced Raman spectroscopy (SERS), laser induced breakdown spectroscopy (LIBS), spark-induced breakdown spectroscopy (SIBS), surface plasmon resonance (SPR), or methods using fluorescence of particle constituents, having the purpose of identifying those constituents of interest.

24. The process of claim 19, further comprising a step for saving the liquid sample in a container or an array of containers for later analysis or a step for delivering the entire collector body containing the liquid sample to an off-line detector for later analysis.

25. The process of claim 19, which comprises injecting a train of discrete microdroplet volumes of the first reagent via said microfluidic injection duct into the collector channel, and further wherein said microvolume droplets of said train are separated by air.

26. The apparatus of claim 1, wherein said discrete microdroplet volume is a precise volume, said volume being ten microliters or less, more preferably 1000 nanoliters or less, and wherein said collector channel has at least one cross-sectional dimension of 1500 microns or less.
